(19) United States
(12) Patent Application Publication
(10) Pub. No.: US 2003/0210694 A1
(43) Pub. Date: Nov. 13, 2003

(54) Content routing architecture for enhanced internet services

(76) Inventors: Suresh Jayaraman, Winnipeg (CA); Sylvanus Agbonifoh Ehikioya, Winnipeg (CA); Jose Alejandro Rueda, Winnipeg (CA)

Correspondence Address: ADE & COMPANY, 1700-360 MAIN STREET, WINNIPEG, MB, R3C3Z3, CA

(21) Appl. No.: 10/283,037

(22) Filed: Oct. 29, 2002

Related U.S. Application Data
(60) Provisional application No. 60/330,720, filed on Oct. 29, 2001.

(51) Int. Cl. H04L 12/56

(52) U.S. Cl. 370/392; 370/401

(57) ABSTRACT

The need for an intelligent content-based router to analyze data and process a client's request quickly and efficiently is increasing with the popularity of the Internet. Current content routers examine only the HTTP based URL request and routes the request to the “best” server for processing. These routers fail to examine different types of TCP-based user requests. The content router we developed examines all type of TCP-based requests. The content router is a core router that simply forwards packets to the edge routers for delivery after performing its content based processing. This router can be replicated to achieve higher performance in large networks. Moreover, by adopting a formal design approach, which is subject to mechanical evaluation using the Z-EVES tool, the correctness of the design is ascertained.

This application claims priority under 35 U.S.C.119 from Provisional Application Serial No. 60/330,720 filed Oct. 29, 2001.

### THE FIELD OF INVENTION

This invention relates to a router for telecommunications data which is responsive to the packet content.

### BACKGROUND OF THE INVENTION

As the number of Internet users and sites continues to increase rapidly, demands on network transmission bandwidths keep growing and the networks connected to the Internet often become heavily loaded. As a result, locating and accessing information in large distributed systems is sometimes difficult and slow. This limits the practical applicability of wide area distributed systems. To address this problem, efforts must be made to use the available bandwidth more effectively.

Transmission links alone do not make a network. Other components such as switches, routers, etc. (and the software that run them) are also parts of a network. One particular component of the network infrastructure that is of interest to this invention is the router. A router is a device that is used to forward packets from one network to another. Every packet must pass through, typically, many routers. The increase in demand for network bandwidth also places a huge demand on network routers [3] and router saturation has an impact on the performance of many distributed computing applications, including electronic commerce. One way to overcome this problem is to develop innovative new router architectures that do routing based on packet content in an effort to minimize wasted bandwidth. The design and prototyping of such a router architecture is our focus.

Current routers do not examine packet data; rather they blindly forward packets based solely on their destination address (which is contained in each packet header). While this minimizes router processing, and thereby increases potential router throughput, it also limits routing flexibility. With content-based routing, it is possible to optimize routing based on application characteristics. This is impossible with conventional routers. Such optimizations can be applied to increase the efficiency of bandwidth use in the Internet.

The present main goal is to develop an intelligent content-based router that examines the data in a packet, and then routes the packet to a destination where it can be most quickly, cheaply, and efficiently processed. Before forwarding packets to their respective destinations, the router examines the data in each packet and based on the data itself as well as the network state, will determine a suitable destination address that can optimize processing of the packet. Thus, a packet may be redirected to a different destination address than was originally specified. This can be used to improve network bandwidth utilization by replicating network services (e.g., web servers) and doing in-network selection of the “optimal” replica to use for a particular packet/request.

The present routing mechanism uses a set of metrics (including such network state information as the cost, speed, and traffic over various links as well as server proximity and workload) in making decisions about which destination to forward packets to. This routing mechanism, which is referred to as Intelligent Content-based Routing will also be useful for any distributed system which can offer the required data at different network locations. It is also extendable to other optimizations based on packet content. Providing fast response, scalability, and consistent operational behaviour are the key challenges in the present router design.

### THE DESCRIPTION OF RELATED ART

The following references have been identified in a search in this field, some of which are relevant to the present invention:

Publications

[1] V. P. Kumar, T. V. Lakshman, and D. Stiliadis, “Beyond Best Effort: Router Architecture for the Differentiated Services of Tomorrow's Internet”, IEEE Communications Magazine, 36(5): 152-164, May 1998.

[2] D. Ghosal, T. V. Lakshman, and Y. Huang, “Parallel Architectures for Processing High Speed Network Signaling Protocols”, IEEE/ACM Transactions on Networking, pages 716-728, December 1995.

[3] Pankaj Gupta, Steven Lin, and Nick McKeown, “Routing Lookups in Hardware at Memory Access Speeds”, IEEE INFOCOM, April 1998.

[4] V. Srinivasan and G. Varghese, “Efficient Best Matching Prefix Using Tries”, Pre- Publication Manuscript, January 1997.

[5] S. Keshav and R. Sharma, “Issues and trends in Router Design”, IEEE COMMUNICATIONS Magazine, 35(6): 144-151, May 1998.

[6] A. Demers, S. Keshav, and S. Shenker, “Design and Analysis of a Fair Queuing Algorithm”, Proceedings of ACM SIGCOMM '89, Austin, September 1989.

[7] Craig Partridge et al, “A 50-Gb/s IP Router”, IEEE/ACM Transactions on Networking, Vol. 6 No. 3, June 1998.

[8] A. Asthana, C. Delph, H. V. Jagadish, and P. Krzyzanowski, “Toward a Gigabit IP Router”, Journal of High Speed Networks, Vol. 1, No. 4, pp. 281-288, 1992.

[9] S. Konstantindou, “Segment Router—A Novel Router Design for Parallel Computers”, IBM T. J. Watson Research Center, Yorktown Heights, N.Y. 10598. (Also published in the Proceedings of ACM SPAA-94, Cape May, N.J., USA, 1994).

[10] Marcel Waldvogel, George Varghese, Jon Turner, Bernhard Plattner, “Scalable High Speed IP Routing Lookups”, Proceedings of SIGCOMM' 97, September 1997.

[11] G. Apostolopoulos, V. Peris, P. Pradhan, and D. Saha, “L5: A Self-Learning Layer-5 Switch”, IBM Research Report RC21461, T. J. Watson Research Center, 1999.

[12] J. M. Spivey, Introducing Z: A Specification Language and its Semantics. Cambridge University Press, 1988.

[13] Z/EVES Version 2.0, ORA Canada, Ottawa, Ontario, K1Z 6X3, CANADA (available at http://www.ora.on.ca/z-eves/welcome.html). (Also associated with this is The Z/EVES Reference Manual by Mark Saaltink and Irwin Meisels, ORA Canada, December 1995; revised September 1997 and October 1999).

[14] Unified Modeling Language Specification, Version 1.3, Object Management Group, Inc., March 1999.

[15] S. A. Ehikioya, “Formal Specification of Intelligent Routing Infrastructure for Electronic Commerce Systems”, Technical Report # TR-CS-22-2000, Dept of Computer Science, U of M, Winnipeg, Canada, June 2000.

[16] “Network Dispatcher: A Connection Router for Scalable Internet Services”, Proceedings of the 7th International World Wide Web Conference, Brisbane, Australia, April 1998.

[17] D. Andresen and T. McCune, “Towards a Hierarchical System for Distributed WWW Server Clusters”, Proceedings of the Seventh IEEE International Symposium on High Performance Distributed Computing (HPDC7), Chicago, IL, July 1998, pp. 301-309.

[18] V. Pai, M. Aron, G. Banga, M. Svendsen, P. Druschel, W. Zwaenepoel, and E. Nahum, “Locality-Aware Request Distribution in Cluster-based Network Servers”, Proceedings of the Eighth International Conference on Architectural Support for Programming Languages and Operating Systems (ASPLOS-VIII), San Jose, Calif., October 1998.

[19] J. Song, E. Levy-Abegnoli, A. Iyengar, and D. Dias, “Design Alternatives for Scalable Web Server Accelerators”, Proceedings of IEEE International Symposium on Performance Analysis of Systems and Software, Austin, Tex., April 2000.

[20] J. Song, E. Levy-Abegnoli, A. Iyengar, and D. Dias, “A Scalable and Highly Available Web Server Accelerator”, IBM Research Report RC 21377, Shorter version appeared in Poster Proceedings of the 8th International World Wide Web Conference (WWW8), Toronto, Canada, May 1999.

[21] Z. Genova and K. Christensen, “Challenges in URL Switching for Implementing Globally Distributed Web Sites”. Proceedings of the Workshop on Scalable Web Services, August 2000, pp. 89-94.

[22] M. Crovella, R. Frangioso, and M. Harchol-Balte. “Connection Scheduling in Web Servers”. Proceedings of the 1999 USENIX Symposium on Internet Technologies and Systems (USITS '99), October 1999.

[23] Cisco Systems Inc,. “Content Routing Protocols”, White Paper, Cisco Systems Inc, Oct. 31, 2000.

[24] V. Cardellini, M. Colajanni, and P. S. Yu. “Geographic Load Balancing for Scalable Distributed Web Systems”. Proceedings of IEEE Mascots 2000, San Francisco, Calif., Aug./Sept. 2000.

[25] J. Challenger, A. Iyengar, P. Dantzig, D. Dias, and N. Mills. “Engineering Highly Accessed Web Sites for Performance”. Web Engineering, Y. Deshpande and S. Murugesan (editors), Springer-Verlag, 2000.

[26] T. Brisco. “DNS Support for Load Balancing”. Technical Report RFC 1974, Rutgers University, April 1995.

[27] P. Mockapetris. “Domain Names—Implementation and Specification”. Technical Report RFC 1035, USC Information Sciences Institute, November 1987.

[28] Andrzej Duda and Mark A. Sheldon, “Content Routing in a Network of WAIS Servers”, 14^{th} International Conference on Distributed Systems, Poznan, Poland, June 1994.

[29] Mark. A. Sheldon, Andrzej Duda, Ron Weiss, James W. O'Toole, Jr., and David K. Gifford, “A Content Routing System for Distributed Information Servers”, Proceedings Fourth International Conference on Extending Database Technology, March 1994.

[30] http://www.unitechnetworks.com/IntelliDNS/Understanding/

[31] http://www.knowware.co.uk/ArrowPoint/solutions/whitepapers/WebNS.html

### U.S. Pat. Nos.

U.S. Pat. No. 5,031,089

Dynamic resource allocation scheme for distributed heterogeneous computer systems

U.S. Pat. No. 5,230,065

Apparatus and method for a data processing system having a peer relationship among a plurality of central processing units

U.S. Pat. No. 5,341,477

Broker for computer network server selection

U.S. Pat. No. 5,341,499

Method and apparatus for processing multiple file system server requests in a data processing network

U.S. Pat. No. 5,459,837

System to facilitate efficient utilization of network resources in a computer network

U.S. Pat. No. 5,774,660

World-wide-web server with delayed resource-binding for resource-based load balancing on a distributed resource multi-node network

U.S. Pat. No. 6,006,264

Method and system for directing a flow between a client and a server

U.S. Pat. No. 6,381,242

Content Processor

U.S. Pat. No. 6,415,323

Proximity-based redirection system for robust and scalable service-node location in an internetwork

U.S. Pat. No. 6,449,647

Content-aware switching of network packets

Sheldon [28] discusses content routing using content tags/labels for documents in a Wide Area Information Service (WAIS) server using a semantic file system, and a source and a catalog file. A query, posed as a predicate, is used to identify keywords in a document. The source file contains the details of host name, host address, database name, port number, and a short description of the database. The catalog file contains a list of short headlines for each file in the database. The architecture described in [28] is similar to the one in [29]. The content routing system has a collection of documents and each document has a content label associated with it. Each content label contains a brief abstract of the documents related to that particular collection. Each query predicate contains a field name and the value to be searched. The mechanism of the design is that the user tries to refine the query as much as possible and then forwards it to the remote servers to find the result. This architecture uses the brute-force searching technique. This architecture is, however, inefficient and slow. In addition, the implementation cost is high because a large number of files are maintained.

Keshav and Sharma [5] discuss primary router design issues: speed and reliability. Reliability is attained using techniques such as: “hot spares, dual power supplies and duplicate data paths through the routers”[5]. The time taken to do lookups in the routing table typically has a great effect on the performance of a router. Decreasing the time it takes to lookup the destination address can increase the speed of the router. As the packet size decreases the number, and hence cost, of route lookups increases. Gupta, et al [3], Srinivasan, et al [4], and Waldvogel, et al [10] are all examples of work addressing efficient routing table lookups. To increase the speed of packet forwarding (including route lookup), architectures with multiple parallel forwarding engines can also be used. A detailed scheme for load balancing parallel forwarding processing is discussed in [2].

Another consideration in designing a router is the scheduling of incoming packets. A simple method is First Come First Serve (FCFS). This method, however, is not an efficient one because the chances of losing packets are high. According to [6], a fair queuing method resolves these problems at a somewhat higher implementation cost.

Partridge, et al [7], Asthana, et al [8], and Konstantinidou [9] discussed hardware design issues related to very high performance (multi-Gigabit) routers. To provide better performance, service and security in the face of increased demand for Internet bandwidth, Network Providers are turning to “differentiated services”. Kumar, et al [1] concluded that the current Internet architecture is not meeting market demands and proposed the use of packet classification, packet scheduling, and buffer management tools to provide enhanced performance. They discussed router-based mechanisms for providing such differentiated services.

Challenger, et al [25] survey various techniques for improving the performance of highly accessed web sites including the use of multiple processors, the caching of dynamic data, and efficient web site design. To reduce traffic to a web server, multiple servers running on different machines may be used to share the load. Such systems are, however, still addressed at a single location. Some sites also use replication to create copies of entire web sites (which may be geographically distributed). Unfortunately, if a replicated site fails it cannot route incoming requests to other sites. A key issue with such systems is locating the sites. One method is to use Round Robin Domain Name Service (RR-DNS) [26, 27], which allows a single domain name to be associated with multiple IP addresses (one per site). But this technique has drawbacks, including possible load imbalance and lost requests if a server fails because the client and name server cannot detect this. To avoid these problems, a TCP router can be used. The function of a TCP router is to accept requests from clients and forward them to the corresponding servers in a round robin fashion (possibly taking server load into account). Servers then respond directly to clients without router involvement. When a server node fails the TCP router can re-direct requests to other web servers. Another technique is the use of web-server accelerators. A web accelerator caches web documents and has a TCP router running on it. When a request from a client arrives, the accelerator first looks in its cache. If the requested object is found it is returned to the client, otherwise the router selects a server node to process the request. Various modifications have been made to these basic ideas.

Hunt, et al [16] discuss a TCP router, called a “Network Dispatcher”, which supports load sharing over several TCP servers. The dispatcher is placed between the front-end clients and the back-end server and forwards requests from the clients to the server nodes. Responses from servers are returned directly, bypassing the network dispatcher. Though the performance of the “router” is good, it does not analyze the packet data but merely forwards packets to the most lightly loaded server node. Cardellini, et al [24] discuss a similar system for geographic load balancing for scalable distributed web systems.

Andresen and McCune [17] discuss a model for hierarchical scheduling of Distributed World Wide Web Server clusters, which process data dynamically. This model has a group of clusters, servers and clients. The server nodes in the clusters are aware of one another's existence. The system maintains information about the load and cache characteristics of all the clusters that are connected through the cluster server as well as network bandwidth information. Each server node in the cluster runs a scheduler algorithm (e.g., Crovella, et al [22]) and one of the processes is responsible for linking these schedulers in a hierarchical way. A client's request is routed to the closest server for processing. If one node fails the system can dynamically change the connection process to any of the other nodes or other clusters using the cluster server.

Vivek, et al [18] discuss a simple strategy, Locality-Aware Request Distribution (LARD), which is a content-based request distribution system. LARD focuses on static content. One of the advantages of this strategy/method over normal cluster-based network servers is that it offers enhanced performance due to its high cache hit rates. The architecture of LARD consists of back-end nodes and a front-end. The front-end is responsible for forwarding requests to the back-end nodes, which constitute the server. In routing a request, this strategy focuses on the content requested and the load on the back-end nodes. LARD uses hashing techniques to locate the requested data. Based on the load on each node, the front-end decides which node should process the given request. When a request arrives, it sends the request to a lightly loaded node, which caches the needed data. If the requested node is fully loaded it will send the request to a new node, which is not heavily loaded. To attain high cache hit rates, LARD depends on replication of its back-end nodes.

Song, et al [20] describe an architecture for a scalable and highly available web server accelerator based on caching data from frequently visited sites. These caches are also known as HTTP accelerators. The web server accelerators use multiple processors to provide more cache memory and higher throughput. The system works as follows: First the client sends a request into the network. A TCP router receives the request and passes it on to a nearby caching site. If the first site is not the owner of the requested object, it determines the owner and sends the request to the owner along with the TCP connection details. The owner fetches the object from its cache or from the back-end server if it is not in the cache. Finally the primary owner returns the requested object either directly or indirectly (through caching sites) to the client.

Song, et al. [19] also provide an alternative design to [20] that includes a load balancer as a separate node, which may also choose to route the requests using content-based information. The load balancer has information about the availability and load details of each caching site. When the load balancer acts as a content router, it analyzes the content and directly routes the requests to the owner site, which will fetch the requested object either from its cache or from the back-end server.

Genova and Christensen [21] describe a Layer 5 switch for implementing distributed web sites. A distributed web site consists of multiple local sites and the switch acts as a front-end for each local site. Each local site has one or more servers and caches information about the load on, and content available from, the server nodes. When a client makes a request, the switch consults the cache to see if the requested object is available in that local site and what the load information is for the server node. If the node is fully loaded and the request data is not available, the request is passed on to the next closest switch. After processing, the requested object is sent back to the client. The routing depends mainly on the data stored in the cache. In a globally distributed site, one can have any number of local sites. Each local site can have any number of server nodes. So, every time a new local site is created or a new server node is added a new cache should be created or the cache size should be increased.

Commercial systems for improving web access times are now becoming available. Cisco [23] for example, discusses various protocols, such as Dynamic Feedback Protocol (DFP), Director Response Protocol (DRP), Web Cache Communication Protocol (WCCP), and Boomerang Control Protocol (BCP) that can be exploited for content routing. The DFP dynamically provides statistical information about the load on and availability of a server. The DRP gives information about the distance between a client and a server and it determines the server that is best capable of processing requested data. The WCCP redirects data to other servers based on information present in the cache. The BCP uses agents to provide network information for routing. The Cisco content router uses information supplied by these protocols to carry out its processing.

IntelliDNS [30] provides a solution for Internet traffic management. The design acts as a global load balancer with intelligence for managing Internet traffic and for content redirection. The set of metrics used for managing traffic and content redirection are network performance, clients proximity and server status. IntelliDNS supports both DNS-based and HTTP-based traffic redirections. If the request is a DNS based request from the client the IntelliDNS gives its own alternate IP address and redirects the client to a content server based on the set of metrics listed above. It also supports protocol re-mapping from HTTP to Hypertext Transfer Protocol Security (HTTPS), Real—Time Streaming Protocol (RTSP) and Microsoft Media Server (MMS). The main drawbacks of IntelliDNS are the design supports only DNS and HTTP based request and it uses a large database to store the client's geographical location and the server location.

Arrowpoint's [31] Web Network Services (WebNS) provides a solution for URL and cookie based intelligent switching. WebNS is designed for name based switching. It uses the full URL and cookie to select the server or site for the user's request. The WebNS switch knows the full information about the client from the cookie and it also knows the user's request and the server to process the client's request based on network information and server status. The Web switch parses the URL to identify the client's request. Based on the request the switch finds a suitable server or site. The Web switch periodically checks for the status of the servers. The client is switched to the new server or site that is selected for processing the request. The requested data is sent back to the client through the shortest path.

### SUMMARY OF THE INVENTION

According to the invention there is provided a method for directing packets of data in a telecommunications network,

wherein the network comprises a plurality of clients, a plurality of servers for supplying those services and a plurality of routers for directing communications over the network;

the method comprising:

providing a router for routing data packets within the network;

providing in the router a packet inspector which examines the data in the packet;

providing in the router a resource inspector which obtains from the network a set of metrics including network state information;

and using the data in each packet and the network state characteristics to determine a suitable destination address that can optimize the processing of the packet.

Preferably the router provides scalable services that can appropriately respond to varying processing loads.

Preferably the router provides the ability to track content requests and respond with appropriate content economically.

Preferably the router provides optimized routing based on application characteristics, thereby increasing bandwidth use on the Internet.

Preferably at least some of the packets are redirected to a different destination address than was originally specified.

Preferably the set of metrics includes network state information including transmission cost, speed, and traffic over various links as well as server proximity and workload.

Preferably the router is arranged to integrate both dynamic data with the limited static data to make intelligent routing decisions, wherein the dynamic data includes the amount of memory and percentage of processor power available at a router, the workload of the router, and the queue length at the router of a network and wherein the static data includes the packet's data and the IP addresses of potential servers that can service the request.

Preferably the verified content-based routing technology that is arranged to provide application-specific intelligent software routing environments to create more efficient geographically distributed databases and other similar applications.

Preferably the packet inspector uses Layers 3 through Layer 7 of the OSI model.

Preferably the Resource inspector finds load and resource information on each server dynamically and provides the collected information to other components of the router in order to process the client request.

Preferably the packet inspector is arranged to examine all type of TCP-based requests.

Preferably the router consists of four major components embedded within a single unit including, in addition to the Packet Inspector and the Resource Inspector, a Scheduler and a Switching Unit.

Preferably the Packet Inspector has two sub-components, the Packet Capture and the Packet Analyzer which enable the unit to capture and extract the data in each packet wherein the extracted data is sent to the scheduler to select an efficient server to process the client's request.

Preferably the packet inspector uses C programming language for capturing the packet and Java for analyzing and extracting the data.

Preferably the Resource Inspector has two sub-components, the Resource Locator and the Resource Manager wherein the Resource Locator collects different resource information from different servers by sending resource agents to different servers and wherein the collected resource information is given to the Resource Manager which organizes and manages the information and forms a Resource Table which contains the resource name and the server address.

Preferably extracted data from a packet is scanned in the Resource Table to locate the server address or addresses to forms a Data Location Table which is sent to the Scheduler for further processing.

Preferably Algorithms for locating the resources and forming the RT and DL tables are substantially as set forth in Algorithms 2 and 3.

Preferably the Scheduler has three sub-components, the Load Inspector, the Cost Manager and the Cache Manager, wherein the Load Inspector extracts the load information of different servers present in the Data Location Table and checks for the server's status, wherein the Cost Manager measures the distance between the client and the participating servers and wherein the Cache Manager collects the best and efficient server address with the extracted data and stores it in the cache.

Preferably the Algorithms for the Load Inspector, the Cost Manager and the Cache Manager are substantially as set forth in Algorithms 4- 7.

Preferably the router is arranged for e-commerce applications using the UML paradigm.

Preferably the router uses the Z specification language to guarantee correctness and prove the reliability of the design.

There is therefore proposed a new design for an intelligent content-based router. The design addresses different problems, such as network traffic, load on different servers and replication of data on different servers and implements a new solution to overcome these problems.

Some advantages of the arrangement described hereinafter are:

Provides a new architecture for an Intelligent Content-Based Router.

Provides different network designs where the newly designed content router can be used effectively and efficiently.

Provides an object model for the newly designed content-based router.

Provides a formal specification of Intelligent Content-based router using the Z specification language to prove the correctness and reliability of the design.

Provides a prototype implementation of the proposed design.

The intelligent content-based router proposed herein consists of four major components embedded within a single unit: Packet Inspector, the Resource Inspector, Scheduler and the Switching Unit. There are proposed new algorithms for implementing the Resource Inspector and the Scheduler. The complete details of each component are discussed later. In this project, much of the application information is utilized from the participating servers and from their status. The router is capable of finding load and resource information on each server dynamically and provides the collected information to other components of the router in order to process the user's request.

The architecture provides a verified, content-based routing technology that can be used to build application-specific intelligent software routing environments. Such environments can be exploited to create more efficient geographically distributed databases and other similar applications [15].

Intelligent content-based routing can provide the following key services: (i) content-based routing, (ii) traffic optimization, (iii) economically scalable services that provide appropriate response to varying processing loads, and (iv) the ability to track content requests and respond with appropriate content.

Of particular current interest, content-based routing can be used to deliver optimized Web response time, which is critical to the success of e-commerce applications. That is, content routing enables the transparent selection of the best site and server for processing/delivering the requested content, thereby providing an enabling technology for more efficient distributed Web site processing. The design also leads to other application-level content routing applications and, potentially, to the development of a hardware intelligent content—based router.

The objectives of this project are to:

Provide an object-oriented design of an intelligent content-based router (a network device that routes packets based on their contents) for e-commerce applications using the UML paradigm.

Model the design using the Z specification language to guarantee correctness and prove the reliability of the design. In particular, Z notation will provide the capability to capture both dynamic and static features and operations of the proposed content-based router.

Increase in number of Internet users increases the load on different servers. Due to the increase in load, locating and accessing data is becoming more and more difficult, which in turn decreases the routing performance. So a need for an efficient router design arise. The present arrangement provides an efficient Intelligent Content-Based Router, which process client's request quickly, cheaply and efficiently. The difference between a normal IP router and the content router is that before forwarding a packet the content router analyzes the data present in a packet, where as a normal IP router just looks into the destination address of a packet.

The Packet Inspector has two sub-components, the Packet Capture and the Packet Analyzer. These two components enable the unit to capture and extract the data in each packet. The extracted data is sent to the scheduler unit to select an efficient server to process the client's request. In capturing the packets, there is used an existing algorithm but in extracting and analyzing data there is used new algorithms. For implementing this component there is used C programming language for capturing the packet, and for analyzing and extracting the data there is used Java.

The Resource Inspector has two sub-components, the Resource Locator and the Resource Manager. The Resource Locator collects different resource information from different servers by sending resource agents to different servers. The collected resource information is given to the Resource Manager. The Resource Manager organizes and manages the information and forms the Resource Table (RT). The Resource Table contains the resource name and the server address. The extracted data (by the Packet Inspector) is scanned in the Resource Table to locate the server address or addresses and forms the Data Location Table (DL table). The DL table is sent to the Scheduler for further processing. Algorithms for locating the resources and forming the RT and DL tables are shown hereinafter (see Algorithms 2 and 3). For implementing this component Java is used.

The Scheduler is a major part of the system. It uses the information sent by the Resource Manager to facilitate intelligent content-based routing. It has three sub-components, the Load Inspector, the Cost Manager and the Cache Manager. The Load Inspector extracts the load information of different servers present in the Data Location Table. It also checks for the server's status. The Cost Manager measures the distance between the client and the participating servers. The Cache Manager collects the best and efficient server address with the extracted data and stores it in the cache. We developed our own algorithms (see Algorithms 4-7) for implementing this component. The best server address is selected based on the information given by the Load Inspector and the Cost Manager to the Scheduler. Finally the client is forwarded to the best-selected server via the switching unit.

### BRIEF DESCRIPTION OF THE DRAWINGS

FIG. 1 Design for metropolitan type of network—Option A.

FIG. 2 Design for metropolitan type of network—Option B.

FIG. 3 Design for metropolitan type of network—Option C.

FIG. 4 Design for Intelligent Content Routing—Wide Area Network.

FIG. 5 Global Network Structure.

FIG. 6 Intelligent Content—Based Routing Architecture.

FIG. 7 Resource Table.

FIG. 8 Data Location Table.

FIG. 9 System Status Table.

FIG. 10 Proximity Table.

FIG. 11 Schedule Table.

FIG. 12 Class diagram for content-based router.

FIG. 13 Activity diagram for content-based router.

FIG. 14 Sequence diagram for content-based router.

FIG. 15 Deployment diagram for content-based router.

FIG. 16 Packet Inspector—Class diagram.

FIG. 17 Packet Inspector—Sequence diagram.

FIG. 18 Packet Inspector—Activity diagram.

FIG. 19 Resource Inspector—Class diagram.

FIG. 20 Resource Inspector—Sequence diagram.

FIG. 21 Resource Inspector—Activity diagram.

FIG. 22 Scheduler Unit—Class Diagram.

FIG. 23 Scheduler Unit—Sequence Diagram.

FIG. 24 Activity Diagram for Load Inspector.

FIG. 25 Activity Diagram for Cost Manager.

FIG. 26 Activity Diagram for Scheduler.

### DETAILED DESCRIPTION

The existing content routers fail to deliver correct information to the right people in appropriate time. The main reason for developing a new intelligent content-based router is to reduce network traffic and to optimize routing cost, which in turn could potentially increase the performance and decrease the latency of the content router. The content router herein examines all types of TCP-based user requests. This new feature makes this design unique when compared with other previous router designs that fail to examine all types of TCP-based request.

The content router design can be used in various network design models. Each design has its own advantages. It includes the following network models: (i) Intelligent content routing for metropolitan networks—Options A, B and Option C, and (ii) Intelligent content routing for wide area networks. These network design models are discussed in detail in the following section.

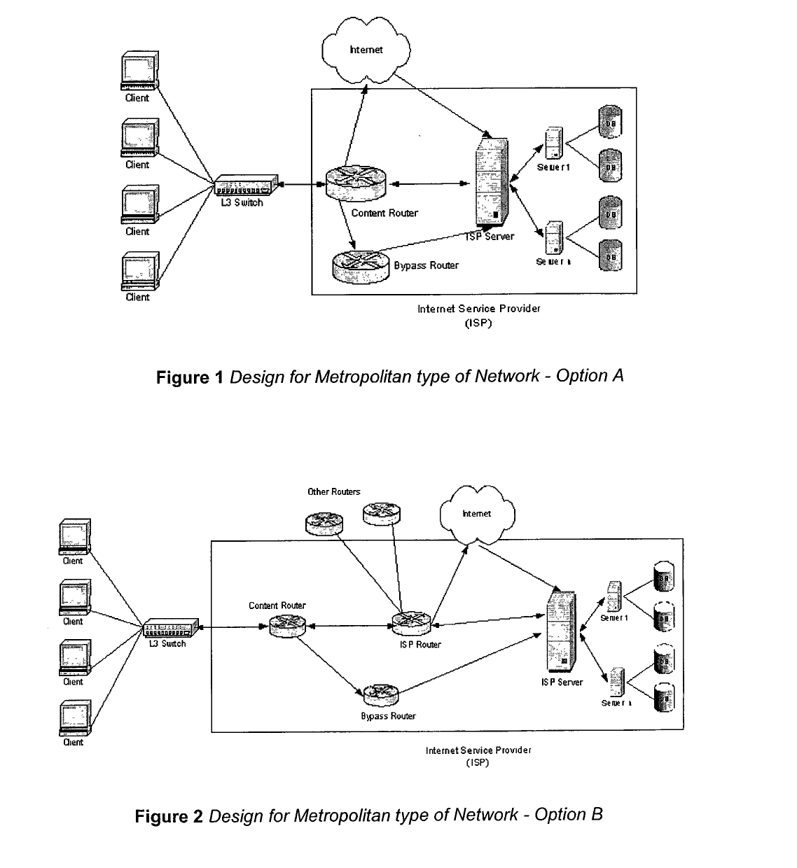

FIG. 1 shows one design for metropolitan networks. In this model, Option A different clients connect to a switch. The Internet Service Provider (ISP) network has a content router connected to an ISP server. A Layer 3 switch, which is outside the ISP network, is connected to the content router. A bypass router is connected to the content router. The ISP server may have many differentiated servers connected to it, which offers different services. Each server has different (data centers) databases on it. The content router is also connected to the Internet. This model is specifically designed for registered services with the ISP. The registered services can be a single company with different branches or it can be different companies with a single major server. The clients send request into the network. The Layer 3 switch captures the user request in a packet format and forwards the packets to the content router present in the ISP network. The main function of a Layer 3 switch is to collect all user requests from different clients on a queue basis. The content router reads the header and tokenizes the data. If the request is a URL-based request the content router sends the request to the Internet and continues to process the next requests. If it is a registered service request, the content router finds a suitable server to process the request based on the information given by the ISP server. The client's request is forwarded to the best appropriate server through the bypass router connected to the content router. The ISP server sends the processed request back to the client via the content router. The response is sent back using different queuing strategies. The three different queuing strategies are: High Priority Queuing (HPQ), Low Priority Queuing (LPQ), and Unprocessed Queuing (UQ).

The requests for registered services and their responses are sent through the HP Queue. The ISP server sends the response to the content router, which sends it back to the Layer 3 switch, which forwards the response to the client. The URL response from the Internet to the content router is stored in the LP Queue. The LP Queue is processed only when the HP Queue is empty. The remaining requests and responses are sent to the Unprocessed Queue. The Unprocessed Queue is processed when the HP and LP Queues are empty.

FIG. 2 shows another design for metropolitan network—Option B. Clients in this model are connected to a Layer 3 switch. The Layer 3 switch is connected to the content router present in the Internet Service Provider network. The content router is connected to an ISP router as well as to the bypass router. The ISP router is connected to the ISP server. The ISP router is also connected to Internet and to other network routers. The ISP server has many differentiated servers connected to it, which offers different services. Each server has different databases on it.

The clients send request into the network. The Layer 3 switch captures the user request in a packet format and forwards the packet to the content router inside the ISP network. The content router reads the header and tokenizes the data. If the client's request is an URL request, the content router forwards the packet to the ISP router. The ISP router forwards the request to the Internet and waits for the response. The ISP router also forwards the requests to their respective destinations, which comes from other routers that are connected to it. Once a response is obtained from Internet the ISP router forwards the response back to the content router. If the request is a registered service request the content router finds a suitable server to process the request based on the information given by the ISP server. The client's request is forwarded to the best appropriate server through the bypass router connected to content router. The processed request is sent back to the client via the content router. The response is sent back to the client using different queuing strategies discussed in Option A network.

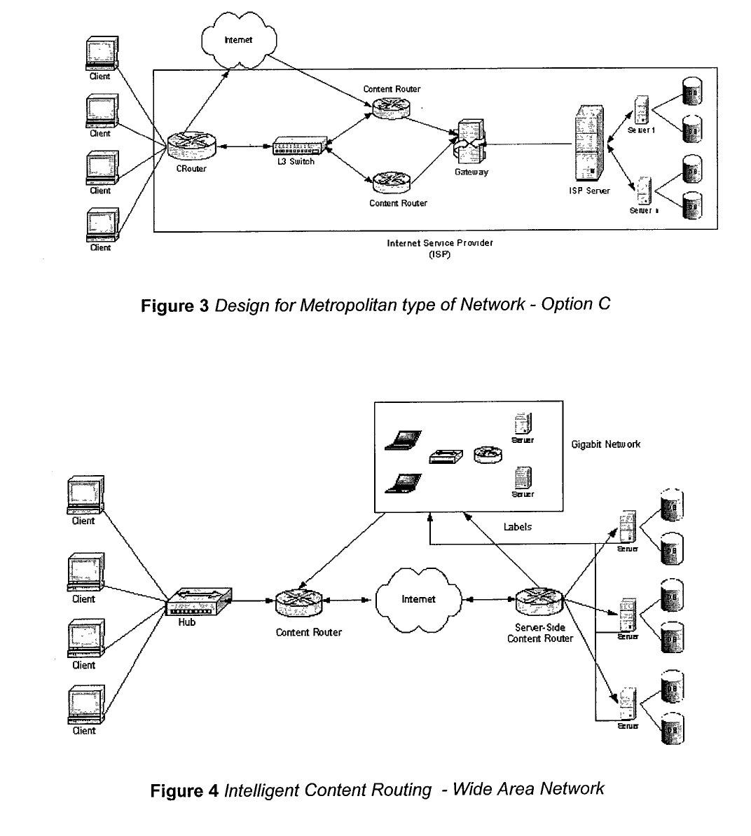

FIG. 3 shows another design for metropolitan network-Option C. The components in Option C network include: clients connected to a network, the ISP has a content router, which is connected to a Layer 3 switch as well as to the Internet. The Layer 3 switch has some content routers connected to it. The content routers present in the ISP network are connected to the ISP network's gateway. The ISP server has many registered servers connected to it. Each server has some data of interest in it. Clients send in their request and the content router present at the entrance of the ISP network captures the user request (in packet format). The content router reads the header of the captured packets and tokenizes the data present in the packet. If the request is an URL request the content router forwards the packet to the Internet for further processing. If the request is for a registered service the content router forwards the packet to the Layer 3 switch. The Layer 3 switch forwards the user request to the content routers in a weighted round robin fashion. The length of the router queue is the weight used for forwarding the user request. Once the content router captures the user request the content router finds a suitable server to process the request based on the information given by the ISP server. The client's request is forwarded to the best appropriate server through the gateway of the ISP network. The different designs models discussed above (Options A-C) are efficient because the content router present inside the ISP Network make routing cheap, quicker and efficient for the registered servers within an ISP Network.

FIG. 4 shows the design for wide area networks. The design consists of several clients, a client side content router, a server side content router and servers with different databases on them. The client side content router is connected to the Internet. A server side content router has different servers connected to it. Each server has different databases on it. In addition to the two routers, there is a Gigabit network connected to the server side content router and the client side content router. This design is well suited for a big company with many branches around the globe. Clients send in their request and the content router captures the request in the form of packets. The data present in the packet is analyzed and tokenized. The tokenized data is sent to the server-side content router through the Internet to find an efficient server to process the client's request. The content router forwards the packet with the tokenized data to the server-side router. The tokenized data sent by the client-side content router is read by the server-side router and finds an efficient server based on a set of metrics, such as system resources, proximity of the client and the server and the status of the server. Based on the metrics the server router selects a server and forwards the client request to the appropriate server. After processing the request the server sends the response back to the server-side content router. The server-side router captures the processed packet. While sending the response back to the client-side content router, the server-side router labels the processed packets and forwards them to the Gigabit network for a quicker response from the server. The Gigabit network captures the labeled packet and forwards the packet back to the client-side content router. The content router captures the response and looks for a label in the packet. If the packet is labeled the content router forwards the packet back to the client without processing the packet. If there is no label the content router starts the processing of packet and forwards the packet to the server router.

The labeling of the packet is done through the Multiprotocol Label Switching (MPLS). The main advantage of using this system is to avoid heavy traffic on the Internet and process requests in an efficient and fast approach. The content router starts processing the packets without knowing the status of the packet that is processed or unprocessed. To avoid multiple processing the processed packets are labeled. So when the content router captures a packet it looks for the label and forwards the packet to the client, thereby enhancing processing time. The network design model for wide area networks is efficient and fast because the response from the server is sent through a different path instead of the same forwarding path. In addition, network traffic is reduced and time taken to process each packet is minimized.

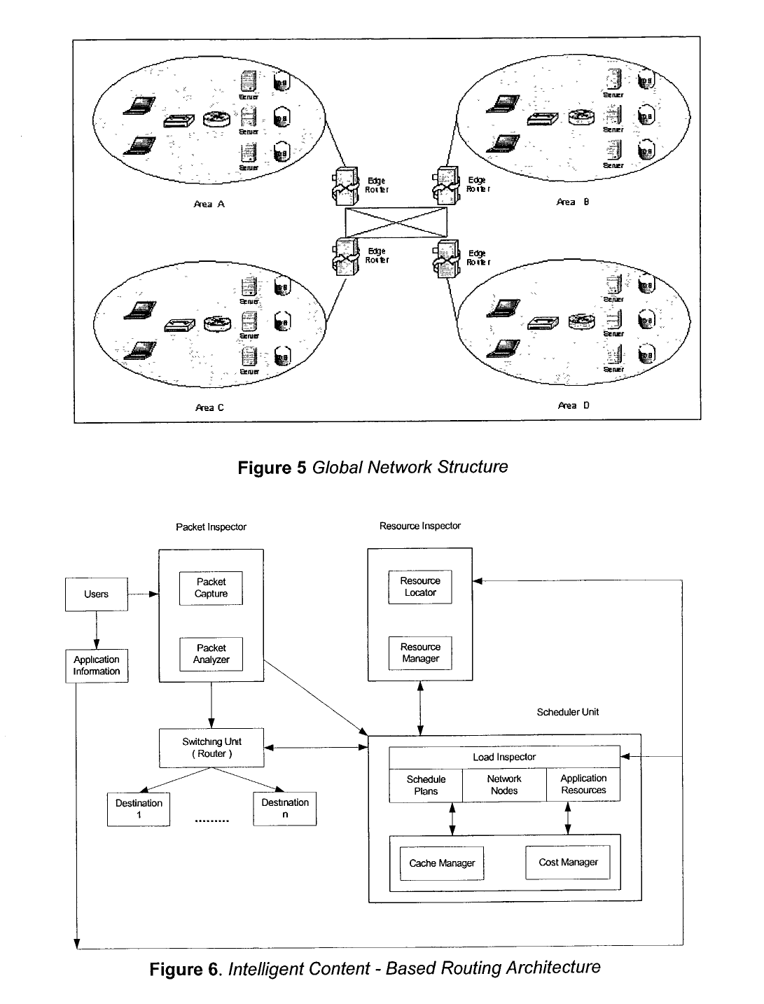

FIG. 5 shows the design of Global Network Structure. This design is an extension of the wide area network design with replication of intelligent content routers in different areas. The different components present in this design are different networks, which are interconnected through edge routers. Each network has different clients connected to a switch, and a content router connected to different servers. The edge routers act as the communication media between these areas. The main functionality of this design is sharing of resources between locations. Each location has a resource agent. These agents are mobile (i.e., they are capable of moving from one place to another). The resource agents move from place to place and collect all the available resource's information and update the resource table present in each local area. When the clients send requests into the network the content router reads the header and analyzes the data and finds a suitable server to process the request. If the requested data in unavailable in the local area it finds a suitable server in a remote location from the resource table maintained by the resource agent. Once a remote server is selected the user request is forwarded to the appropriate server through the edge routers. If there is any change in resources, all the resource tables are updated by the resource agents. Sending a broadcast message to all locations can also perform the update operation.

### The Content Router Architecture

The high-level system architecture of the designed intelligent content-based router is shown in FIG. 6. Each component is briefly described below.

The Packet Capture and Packet Analyzer module enables the unit to capture and extract the data in each packet of a user's request. This data is the content that is routed to the appropriate server at that moment based on a set of metrics. This component of the system intercepts the user's request data stream in the form of packets and then extracts the data content (i.e., the payload) it contains for routing.

A core component of the system is the Resource Inspector. The main job of the Resource Inspector is to assemble vital information about the resources available in the system for ease of access and for fast decision-making. The resources for e-commerce and other Internet applications are often stored in databases (at the participating servers). The Resource Inspector collects resource information about the number of databases available in the system, the addresses of these databases, and permission data (such as who can obtain the database addresses) and stores the data collected in a resource table. This resource table is used to feed the load-balancing unit (discussed below). To implement this component, we adopted intelligent mobile agent technology. Mobile agents are suitable because they enable us to seamlessly and transparently assess servers (at remote locations) and retrieve appropriate data of interest. The agents only need to know the address (IP address or full domain name) of the resource and a known set of database types. The agents can retrieve the metadata of each database, such as the name of the schemas, the description of the schemas, and table definitions, etc. This information is necessary to make informed judgements on where to find the available resources for the application. The databases are transparent to the system.

The Scheduler Unit, a major part of system, uses the information assembled by the Resource Inspector to facilitate content-based routing. It is responsible for scheduling and allocating transactions to the various servers for execution based on the current processing/work load information of each server. This unit answers questions such as: (i) How busy is each server? (ii) Which server can process the request in the shortest time? We used existing queuing and scheduling algorithms (as in operating systems and other distributed systems) to realize an efficient and robust system.

Finally, the Switching Unit is responsible for the actual redirection of the user's payload based on the contents of the packets. Using the assembled data of the Resource Inspector and the recommended scheduling plans of the Scheduler Unit (routing tables, network nodes, application resources, etc), the Switching Unit routes the user payload to the selected specific destination. The decision about where to go is based on the accumulated and cached information from the Resource Inspector and the Scheduling Unit.

### The Design Specification of the Architecture

To develop a robust and fail safe system, formal specification is one of the approaches that can be used. The specification describes the requirements and functionality of the system and controls the software complexity and enhances the quality and reliability of the system. A formal specification is usually written using a formal specification language, which has a well-defined syntax and semantics. The formal specification language used is Z because it has tool support for typechecking is the syntax and semantics of Z-based specifications

The different operations that are performed are: defining the structure of a packet, creating a packet, creating a user list, adding new users, logging into the system, list for logged users, sending a request. The basic set types that are used in this specification are defined below. The first few set types upto DATA are the different fields present in an IP packet.

[IPHEADERLEN, TYPEOFSERVICE, FLAGS, FRAGOFFSET, IDENTIFICATION, TIMETOLIVE, PROTOCOL, HEADERCHECKSUM, TOTALLENGTH, OPTIONS, DATA, VERSION]

The name and password types are used to store the registered users list and password.

[NAME, PASSWD, SERVERADDRESS, RESOURCENAME]

The CPUAvail, MEMAvail and QueueLEN are the load details of different servers and DISTANCE is the distance between the server and the client.

| | |
|---|---|
| CPUAvail□□□ | □ |
| MEMAvail□□□ | □ |
| QueueLEN□□□ | □ |
| DISTANCE□□□ □ | |

The serverstatus type gives the status of the participating server.

| | | |
|---|---|---|
| SERVERSTATUS | ::□□Active | □□Down |
| BOOLEAN | ::□□True | □□False |

A RESPONSE is a message or a result given by the system after each operation performed on it. The different responses given by the content router notify the network administrator about the router's performance. The different responses given by the system are defined below.

RESPONSE:

| | |
|---|---|
| | □□PacketDefined |
| | □□PacketCreated |
| | □□NewUserAdded |
| | □□LoggedInSuccessfully |
| | □□RequestSent |
| | □□ResourceTableUpdated |
| | □□ServerAddressFound |
| | □□SystemStatusObtained |
| | □□DistanceObtained |
| | □□ScheduleTableFormed |
| □□□□ | ¹¹□□DestAddressChanged |
| | □□CacheUpdated |

The first aspect of the system is to describe its state space. Each operation in the system is defined within a schema. A schema has two parts, the declaration part and the predicate part. The parts are separated by a central line. The part above the central line is the declaration and below the central line is the predicate. The predicate part specifies the requirements of the values of the variables defined in the declaration part. The PacketDef schema (defined below) gives the structure of an Internet Protocol (IP) packet. Each packet contains the version of IP currently used, IP header length indicates the header length, Type of Service, Total length of the IP packet, Identification indicates the current packet, Flags, Fragment Offset, Time-to-Live is a counter which gradually decrements down to zero, and the packet is discarded. The Protocol indicates the next level protocol of packet such as TCP, UDP, etc. Header checksum ensures IP header integrity, Sourceip specifies where the packet is coming from, Destip specifies the packet's destination address, Options provides additional security and finally the packet has the Data. The result for this schema is “PacketDefined”.

□□PacketDef□□□□□□□□□□□□□□□□□□□□□□□□□□□□□□□□□□

| | | |
|---|---|---|
| □ver: | | VERSION |
| □ipheaderlen: | | IPHEADERLEN |
| □tos: | | TYPEOFSERVICE |
| □tl: | | TOTALLENGTH |
| □id: | | IDENTIFICATION |
| □flg: | | FLAGS |
| □frgoff: | | FRAGOFFSET |
| □tol: | | TIMETOLIVE |
| □proto: | | PROTOCOL |
| □hc: | | HEADERCHECKSUM |
| □sourceip, | destip: | SERVERADDRESS |
| □op: | □ | OPTIONS |
| □data: | □ | DATA |
| □Re!: | | RESPONSE |
| □□□□□□□□□□□□□□□□ | | |
| □ver | □ | □ |
| □ipheaderlen | □ | □ |
| □tos | □ | □ |
| □tl | □ | □ |
| □id | □ | □ |
| □flg | □ | □ |
| □frgoff | □ | □ |
| □tol | □ | □ |
| □proto | □ | □ |
| □hc | □ | □ |
| □sourceip | □ | □ |
| □destip | □ | □ |
| □Re! | = | PacketDefined |

□□□□□□□□□□□□□□□□□□□□□□□□□□□□□□□□□□□□□□□

The next schema, PacketCreation, captures the inputs needed for creating the packet. The fields discussed in the previous schema cannot be empty except the op (options) and data fields. A packet can be an empty packet without any data or it can carry some data for transmission. Once all the fields are filled up the packet is created and it is ready for transmission. The result for this schema operation is “PacketCreated”.

□□PacketCreation □□□□□□□□□□□□□□□□□□□□□□□□□□□□□□□
□□PacketDef
□vers?: VERSION
□iph?: IHL
□typos?: TYPEOFSERVICE
□totlen?: TOTALLENGTH
□identi?: IDENTIFICATION
□flag?: FLAGS
□fragoff?: FRAGOFFSET
□timetol?: TIMETOLIVE
□prototype?: PROTOCOL
□hcheck?: HEADERCHECKSUM
□sip?, dip?: SERVERADDRESS
□opt?: □ OPTIONS
□req?: □ DATA
□Re!: RESPONSE
□□□□□□□□□□□□□□□□
□ver = vers?
□ipheaderlen = iph?
□tos = typos?
□tl = totlen?
□id = identi?
□flg = flag?
□frgoff = fragoff?
□tol = timetol?
□proto = prototype?
□hc = hcheck?
□sourceip = sip?
□destip = dip?
□op = opt?
□data = req?
□Re! = PacketCreated
□□□□□□□□□□□□□□□□□□□□□□□□□□□□□□□□□□□□□□□□

The next schema operation is maintaining a user list and a login list for those people who login to the system. Each user has a username and a password to login. The main reason for maintaining a user list is that in all e-commerce applications only registered users are allowed to perform some of the core transactions. In order to commit the transactions a user list is maintained and verified. Each time a user logs in his/her password is verified before committing a transaction. The next set of schemas describes the maintenance of registered user list.

| | |
|---|---|
| □□UserList | □□□□□□□□□□□□□□□□□□□□□□□□□□□□□□□□□□ |
| □users: | NAME □ PASSWD |

| | |
|---|---|
| □loggedusers: | □ NAME |

□□□□□□□□□□□□□□□□□□□□□□□□□□□□□□□□□□□□□□□□

The InitialUserList schema contains the initial value of the users list and login list. Initially there are no users. So the two fields are empty.

□□InitialUserList□□□□□□□□□□□□□□□□□□□□□□□□□□□□□□□
□UserList
□□□□□□□□□□□□□□□□
□users = □
□loggedusers = □
□□□□□□□□□□□□□□□□□□□□□□□□□□□□□□□□□□□□□□□□

The AddUser schema captures the operation of adding a new user to the system. This operation has a change in the class UserList. When a new user is added there are two inputs name and password and Re! is the result obtained for this schema.

□□AddUser□□□□□□□□□□□□□□□□□□□□□□□□□□□□□□□
□□UserList
□name?: NAME
□passwd?: PASSWD
□Re!: RESPONSE
□□□□□□□□□□□□□□□□
□name? □ dom users
□users' = users □ □□name? □ passwd?□□
□Re! = NewUserAdded
□□□□□□□□□□□□□□□□□□□□□□□□□□□□□□□□□□□□□□□□

The name that is given by the user must not be in the UserList. If it exists the user has to give a new name to register. The name and password field should not be empty. Once the user registers by supplying the name and password it is added to the users list. The result obtained is NewUserAdded.

All the registered users can login to the system. The inputs given are name and password and the output Re! is the result.

□□Login□□□□□□□□□□□□□□□□□□□□□□□□□□□□□□□
□□UserList
□name?: NAME
□passwd?: PASSWD
□Re!: RESPONSE
□□□□□□□□□□□□□□□□
□name? □ dom users
□passwd? □ ran □□name? □ passwd?□□
□loggedusers' = loggedusers □ □name?□
□Re! = LoggedInSuccessfully
□□□□□□□□□□□□□□□□□□□□□□□□□□□□□□□□□□□□□□□□

The name given by the user is checked in the users list for the registered user. If it is a registered user, the name is checked for its corresponding password which is mapped to the user name. If both are valid, the user name is added to the login users list and the result obtained is “LoggedinSuccessfully”.

The UserRequest schema models sending a user request to the network. The input supplied for this operation are, the user name and the data to send. Re! is the result obtained.

□□UserRequest□□□□□□□□□□□□□□□□□□□□□□□□□□□□□□□
□□UserList
□□PacketCreation
□name?: NAME
□request?: DATA
□Re!: RESPONSE
□□□□□□□□□□□□□□□□
□name? □ loggedusers
□data = request?
□Re! = RequestSent
□□□□□□□□□□□□□□□□□□□□□□□□□□□□□□□□□□□□□□□□

The name given by the user is checked in the login users list. If the user name is not present in the list the user has to login. If the user is in the list, the request is sent to the network. The result obtained is “RequestSent”.

The next schema operation is to maintain a server list, which has the list of all the registered servers.

□□ServerAddressList□□□□□□□□□□□□□□□□□□□□□□□□□□□□□□□
□serverlist: □ SERVERADDRESS
□□□□□□□□□□□□□□□□□□□□□□□□□□□□□□□□□□□□□□□□

The Resource Table schema maintains a list of resource name and its corresponding server address.

□□ResourceTable□□□□□□□□□□□□□□□□□□□□□□□□□□□□□□□
□resourcelist: RESOURCENAME □ SERVERADDRESS
□□□□□□□□□□□□□□□□□□□□□□□□□□□□□□□□□□□□□□□□

The Initial Resource Table list contains the initial value of the resource list.

□□InitialResourceTable □□□□□□□□□□□□□□□□□□□□□□□□□□□□
□Resource Table
□□□□□□□□□□□□□□□□
□resourcelist = □
□□□□□□□□□□□□□□□□□□□□□□□□□□□□□□□□□□□□□□□□

The AddEntries schema describes the addition of new resources to the system. This operation affects the ResourceTable. When a new resource is added, two inputs are required and a response is obtained.

□□AddEntries □□□□□□□□□□□□□□□□□□□□□□□□□□□□□□□□□□□
□□ResourceTable
□resourcename?: RESOURCENAME
□loc?: SERVERADDRESS
□Re!: RESPONSE
□□□□□□□□□□□□□□□□
□loc? □ ran resourcelist
□resourcelist' = resourcelist □ □□resourcename? □ loc?□□
□Re! = ResourceTableUpdated
□□□□□□□□□□□□□□□□□□□□□□□□□□□□□□□□□□□□□□□□

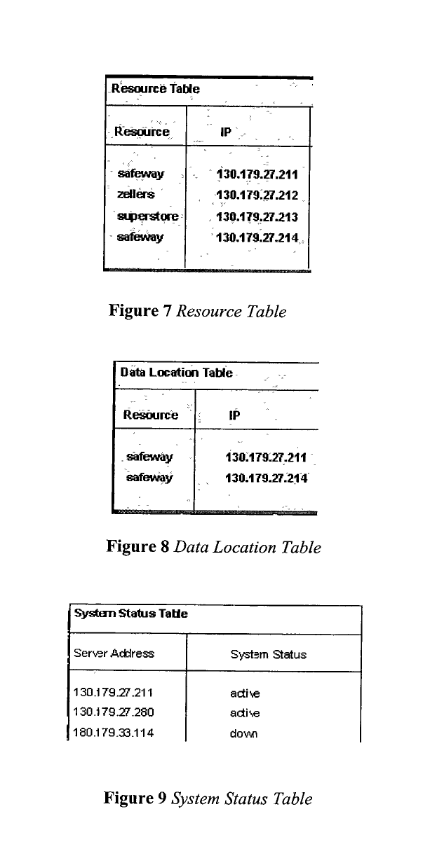

The two inputs are resource name and server address. The condition to add the resources to the table is that the server address should not be in the resource list. If the server's address exists, the corresponding resource name is checked. If the resource name is different, the resource and the address are added otherwise they are discarded. If the resource name exists in the list the corresponding server address is checked with the input server address. If both the addresses are different the resource name and the server address are added to the list else the resource is discarded. The result obtained is “ResourceTableUpdated”. FIG. 7 shows the structure of the Resource Table.

The Data Location Table schema has two components; matchedentries and the dltserverlist. The matchedentries maintains a list of all instances of resources and server address from ResourceTable based on users request. The dltserverlist maintains a separate list for all the server address stored in the matchedentires.

□□DataLocationTable□□□□□□□□□□□□□□□□□□□□□□□□□□□□□□
□matchedentries: RESOURCENAME □ SERVERADDRESS
□dltserverlist: □ SERVERADDRESS
□□□□□□□□□□□□□□□□□□□□□□□□□□□□□□□□□□□□□□□□

The InitialDLTable has zero entries when the system is activated.

□□InitialDLTable □□□□□□□□□□□□□□□□□□□□□□□□□□□□□□□
□DataLocationTable
□□□□□□□□□□□□□□□□
□matchedentries = □
□dltserverlist = □
□□□□□□□□□□□□□□□□□□□□□□□□□□□□□□□□□□□□□□□□

Each entry in the DataLTable has a resource name and its corresponding server address. FIG. 8 shows the structure of the Data Location Table.

The FindServerAddress schema describes finding a server address from the Resource table list for the tokenized data. The input for this schema is tokenized data and the output is server address.

□□FindServerAddress□□□□□□□□□□□□□□□□□□□□□□□□□□□□□□□
□□DataLocationTable
□□ResourceTable
□tokenizeddata?: RESOURCENAME
□loc!: SERVERADDRESS
□Re!: RESPONSE
□□□□□□□□□□□□□□□□
□tokenizeddata? □ dom resourcelist
□loc! = resourcelist (tokenizeddata?)
□matchedentries' = matchedentries □ □□tokenizeddata? □ loc!□□
□dltserverlist' = dltserverlist □ □loc!□
□Re! = ServerAddressFound
□□□□□□□□□□□□□□□□□□□□□□□□□□□□□□□□□□□□□□□□

The input is checked in the resource list maintained by the resource table. If the tokenized data is not in the list, the packet is routed to the original destination address present in the packet. If the tokenized data exists in the list the corresponding server address is obtained. Both the data and the server address are stored in the data location table and the server address is also stored in a separate server list maintained by the Data Location Table. The result for this schema is “ServerAddressFound”.

The next schema gives the structure of the System Status Table. It has the server address and the status of the server i.e. active or down.

□□SystemStatusTable□□□□□□□□□□□□□□□□□□□□□□□□□□□□□□□
□statusentries: SERVERADDRESS □ SERVERSTATUS
□□□□□□□□□□□□□□□□□□□□□□□□□□□□□□□□□□□□□□□□

The Initial System status list is empty. FIG. 9 shows the structure of the System Status Table.

□□InitialSST □□□□□□□□□□□□□□□□□□□□□□□□□□□□□□□
□SystemStatusTable
□□□□□□□□□□□□□□□□
□statusentries = □
□□□□□□□□□□□□□□□□□□□□□□□□□□□□□□□□□□□□□□□□

The Ping function defined below is used to find the status of a server.

□ping: SERVERADDRESS □ SERVERSTATUS

The FindSystemStatus schema gives the status of the system. This schema takes the serverip as the input and gives the server status as output. The response is stored in Re!.

□□FindSystemStatus □□□□□□□□□□□□□□□□□□□□□□□□□□□□□□□
□□SystemStatusTable
□□ServerAddressList
□serverip?: SERVERADDRESS
□servstatus!: SERVERSTATUS
□Re!: RESPONSE
□□□□□□□□□□□□□□□□
□serverip? □ serverlist
□servstatus! = ping(serverip?)
□statusentries' = statusentries □ □□serverip? □ servstatus!□□
□Re! = SystemStatusObtained
□□□□□□□□□□□□□□□□□□□□□□□□□□□□□□□□□□□□□□□□

The input serverip is checked in the server list maintained by the ServerAddressList schema. If the serverip is found, the ping function is applied on the server to find the server's status. The status is stored in servstatus!. The final status with its corresponding server address is stored in the system status table. The result otained is “SystemStatusObtained”.

The ProximityTable schema defines the structure of the Proximity table. It has two columns server address and distance.

□□ProximityTable □□□□□□□□□□□□□□□□□□□□□□□□□□□□□□□
□serveraddress: SERVERADDRESS
□dsitance: DISTANCE
□distentries: SERVERADRESs □ DISTANCE
□□□□□□□□□□□□□□□□□□□□□□□□□□□□□□□□□□□□□□□□

Initially the Proximity table is empty.

□□InitialPT□□□□□□□□□□□□□□□□□□□□□□□□□□□□□□□
□ProximityTable
□□□□□□□□□□□□□□□□
□distentries = □
□□□□□□□□□□□□□□□□□□□□□□□□□□□□□□□□□□□□□□□□

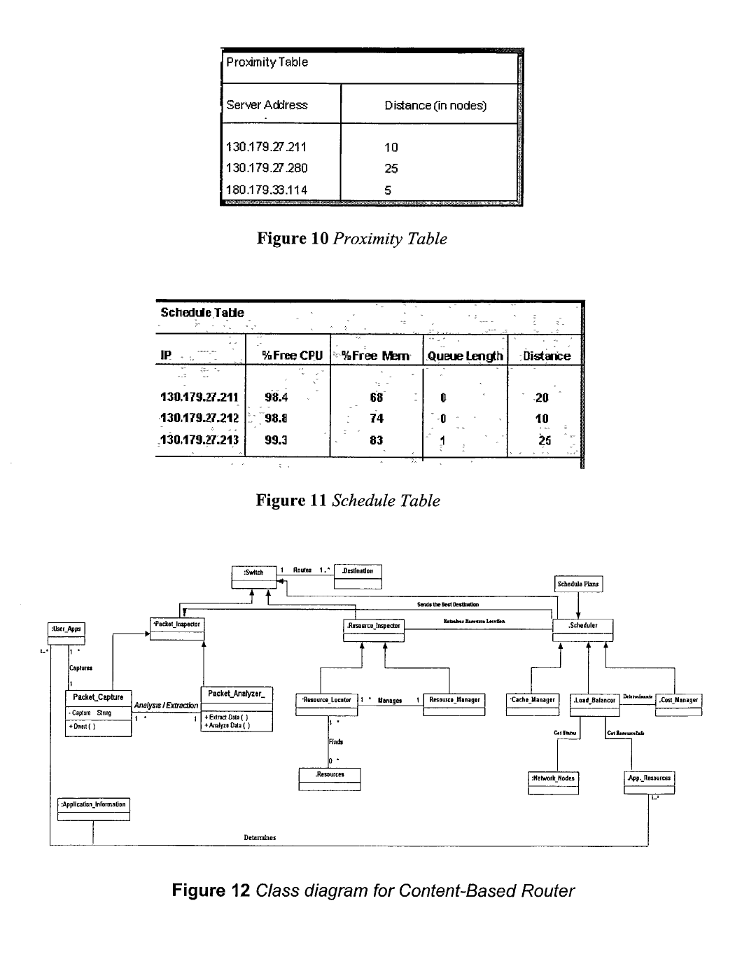

Traceroute is the function used to find the distance between the content router and the server. FIG. 10 shows the structure of the Proximity Table. □traceroute: SERVERADDRESS □ DISTANCE

The FindDistance schema gives the distance between the content router and the server. It takes one input (serverip?) and produces one output (distance!) and the response is stored in Re!.

□□FindDistance □□□□□□□□□□□□□□□□□□□□□□□□□□□□□□□
□□ProximityTable
□□ServerAddressList
□serverip?: SERVERADDRESS
□distance!: DISTANCE
□Re!: RESPONSE
□□□□□□□□□□□□□□□□
□serverip? □ serverlist
□serverip? □ dom traceroute
□distance! = traceroute(serverip?)
□distentries' = distentries □ □□serverip? □ distance!□□
□Re! = DistanceObtained
□□□□□□□□□□□□□□□□□□□□□□□□□□□□□□□□□□□□□□□□

The input serverip is checked in the server list to find whether the input serverip is valid. If it exists in the server list the traceroute function is applied to the input serverip and the distance is stored in the output variable. Once the distance is obtained the Proximity table is updated with the distance and the corresponding server address. The response obtained is “DistanceObtained”.

The LoadDetails schema encapsulates the structure of the load details. The different components that are necessary for obtaining the load details are: percentage of free CPU available (CPUAvail), percentage of free memory available (MEMAvail), processor queue length (QueueLEN), and the distance between the router and the server (DISTANCE). This encapsulated structure is used by the loadinfolist function defined in ScheduleTable schema.

□□LoadDetails□□□□□□□□□□□□□□□□□□□□□□□□□□□□□□□
□CpuInfo: CPUAvail
□MemInfo: MEMAvail
□QueueLen: QueueLEN
□Dist: DISTANCE
□□□□□□□□□□□□□□□□□□□□□□□□□□□□□□□□□□□□□□□□
□loadinfo: SERVERADDRESS □ LoadDetails

The Schedule Table schema gives the structure of the schedule table. The different fields present are serveraddress, percentage of CPU avialable, percentage of memory available, length of the processor queue and the distance between the router and the server. FIG. 11 shows the structure of the Schedule Table.

□□ScheduleTable□□□□□□□□□□□□□□□□□□□□□□□□□□□□□□□
□loadinfolist: SERVERADDRESS □ LoadDetails
□□□□□□□□□□□□□□□□□□□□□□□□□□□□□□□□□□□□□□□□

The next schema, FormScheduleTable, describes the formation of the schedule table. The input for this schema is the server address and the output is the load details discussed above. The input is checked in the server list maintained in the data location table. If the server address exists in the data location table, the status of the server is checked in the system status table. The precondition for finding the load details is that the server status should be active. If the server status is down the corresponding server address is discarded and the next server address is processed. Once the server status is active, the load details of the input server are obtained by applying the loadinfo function, which is defined above. After obtaining the load details the schedule table is updated with the load information with the corresponding server address mapped to it. The result obtained for this schema is “ScheduleTableFormed”.

□□FormScheduleTable□□□□□□□□□□□□□□□□□□□□□□□□□□□□□□□
□□ScheduleTable
□□DataLocationTable
□□ProximityTable
□□SystemStatusTable
□serverip?: SERVERADDRESS
□cpuinfo!: CPUAvail
□meminfo!: MEMAvail
□qlen!: QueueLEN
□dist!: DISTANCE
□serverstatus!: SERVERSTATUS
□ld: LoadDetails
□Re!: RESPONSE
□□□□□□□□□□□□□□□□
□serverip? □ dltserverlist
□serverstatus! = statusentries (serverip?)
□serverstatus! = Active
□ld = loadinfo(serverip?)
□cpuinfo! = ld . CpuInfo
□meminfo! = ld . MemInfo
□qlen! = ld . QueueLen
□dist! = ld . Dist
□loadinfolist' = loadinfolist □ □□serverip? □ ld□□
□Re! = ScheduleTableFormed
□□□□□□□□□□□□□□□□□□□□□□□□□□□□□□□□□□□□□□□□

Different functions used to find the best destination address are: getLoadDetails, isBetter, and theBestIP. The getLoadDetails returns load details for the corresponding server address present in the ScheduleTable.

□getLoadDetails: SERVERADDRESS □ LoadDetails

The isBetter function returns the better server address between two different servers based on the load information obtained from the ScheduleTable. The different load details used for comparison are percentage of CPUAvailable, percentage of free MEMAvail, length of the processor queue (i.e., QueueLEN), and the DISTANCE between the content router and the server.

□isBetter: LoadDetails □ LoadDetails □ BOOLEAN
□□□□□□□□□□□□□□□□
□□ld1, ld2: LoadDetails □□□ld1□ ld2□ □ dom isBetter
□ □□isBetter □ld1□ ld2□ = True
□ □ ld1 . CpuInfo □ ld2 . CpuInfo
□ □ ld1 . Dist □ ld2 . Dist
□ □ ld1 . QueueLen □ ld2 . QueueLen
□ □ ld1 . MemInfo □ ld2 . MemInfo
□ □ ld1 . LoadDetails = ld2 . LoadDetails

The next function, theBestIP, uses the isBetter function to find the best destination server for processing the user request. The inputs supplied for this function are two server addresses and the output obtained is the best server address.

□theBestIP: □ SERVERADDRESS □ SERVERADDRESS
□□□□□□□□□□□□□□□□
□□sa: □ SERVERADDRESS
□ □□□Tbip: SERVERADDRESS □□Tbip □ sa
□ □□theBestIP (sa) = Tbip
□ □ □□ip: SERVERADDRESS □□ip □ sa
□ □□isBetter □□getLoadDetails (Tbip)□□ □getLoadDetails( ip)□□
□ = True□

The next schema operation is RewriteIPHeader. The main function of the RewriteIPHeader schema is to rewrite the original packet's destination address with the new server address. The inputs for this operation are newdestip? and packet id (i.e. pid?). The original packet's id is checked with the input pid?. If both ids are equal the packet's destination address is changed to the new server address. The result for this schema is “DestAddressChanged”.

□□RewriteIPHeader□□□□□□□□□□□□□□□□□□□□□□□□□□□□□□□
□□PacketCreation
□□ScheduleTable
□newdestip?: SERVERADDRESS
□pid?: IDENTIFICATION
□Re!: RESPONSE
□□□□□□□□□□□□□□□□
□pid? = id
□newdestip? = theBestIP □dom loadinfolist□
□destip = newdestip?
□Re! = DestAddressChanged
□□□□□□□□□□□□□□□□□□□□□□□□□□□□□□□□□□□□□□□□

The CacheManager schema maintains a list in the cache. The list has the resource name and best-selected server address.

□□CacheManager □□□□□□□□□□□□□□□□□□□□□□□□□□□□□□□
□cachelist: RESOURCENAME □ SERVERADDRESS
□□□□□□□□□□□□□□□□□□□□□□□□□□□□□□□□□□□□□□□□

The initial list of the CacheManager is empty.

□□InitialCL□□□□□□□□□□□□□□□□□□□□□□□□□□□□□□□
□CacheManager
□□□□□□□□□□□□□□□□
□cachelist = □
□□□□□□□□□□□□□□□□□□□□□□□□□□□□□□□□□□□□□□□□

The UpdateCache schema updates the CacheManager's list by adding the best server address and its resource name. The input supplied for this operation is serverip?. The theBestIP function is applied to select the best server address from the list maintained by the ScheduleTable. The resource name and the server address are updated in the CacheManager's list. The response from this operation is “CacheUpdated”.

□□UpdateCache□□□□□□□□□□□□□□□□□□□□□□□□□□□□□□□
□□CacheManager
□□ScheduleTable
□data!: RESOURCENAME
□serverip?: SERVERADDRESS
□Re!: RESPONSE
□□□□□□□□□□□□□□□□
□dom loadinfolist □ dom theBestIP
□serverip? = theBestIP □dom loadinfolist□
□cachelist' = cachelist □ □□data! □ serverip?□□
□Re! = CacheUpdated
□□□□□□□□□□□□□□□□□□□□□□□□□□□□□□□□□□□□□□□□

Using the different operations defined in the system, the Content Router can be defined as follows.

```
ContentRouter□□□ (( ResourceTable □ SystemStatusTable □ ProximityTable) □
        UserRequest □ FindServerAddress □ FindSystemStatus □
            FindDistance □ LoadDetails □ FormScheduleTable □
                RewriteIPHeader □ UpdateCache)
```

While some of the operations mentioned above are executed sequentially others are executed in parallel. When the system is started the ResourceTable, SystemStatusTable, and ProximityTable operations are executed in parallel. These three operations are executed continuously until the system is stopped. The rest of the operations are executed sequentially and are done based on the UserRequest.

### Object Model and Functionality

This section presents an object model for the designed content router and explains the different functionality of the design. Developing a software system is becoming complex and expensive due to the change from single-tier to multi-tier architecture and distributed systems. To develop sophisticated software system one requires creativity, ability to learn and analyze the problem and should have knowledge or experience in different programming languages. To avoid the complexity and to maintain the quality and reliability of the system the concept of object orientation comes into existence. The object models in this project are developed using Unified Modeling Language (UML). The UML has many object-oriented notations, which is used to analyze and design sophisticated applications. The main reason for using UML for developing the object models is that it has many specialized notational elements, which supports complex applications. The different types of UML diagrams we have used in this design are: class diagram, activity diagram, sequence diagram and deployment diagram. FIG. 12 shows the class diagram for content-based router.

The class diagram in FIG. 12 shows the different classes present in the application. It also specifies the relationship between different classes. While creating a large complex system, the application is divided into different modules. The different modules present in this project are Packet Inspector, Resource Inspector and Scheduler. Each module is further divided into sub-modules. Each module has it's own class diagram.

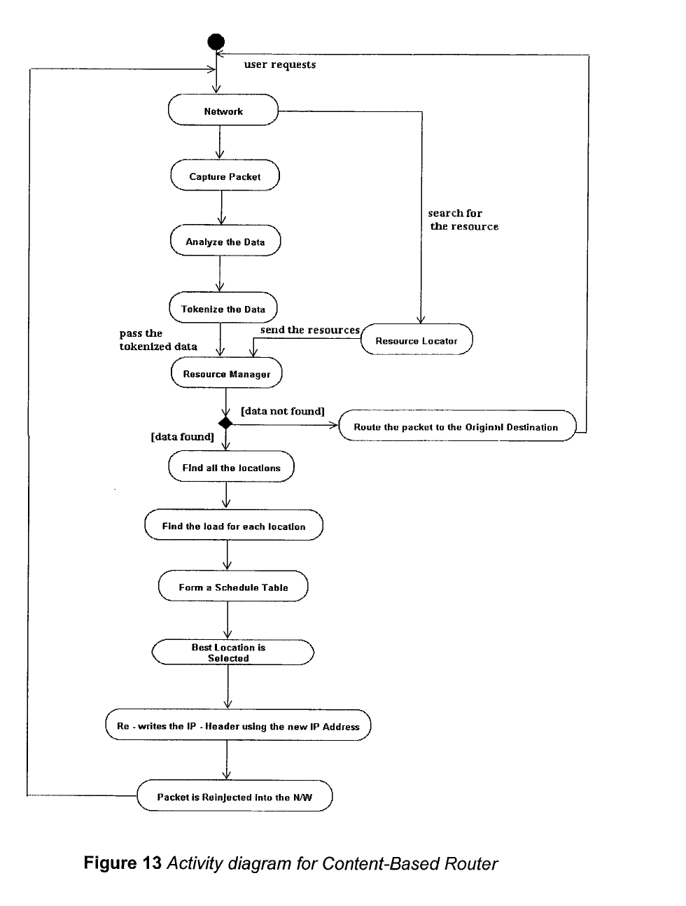

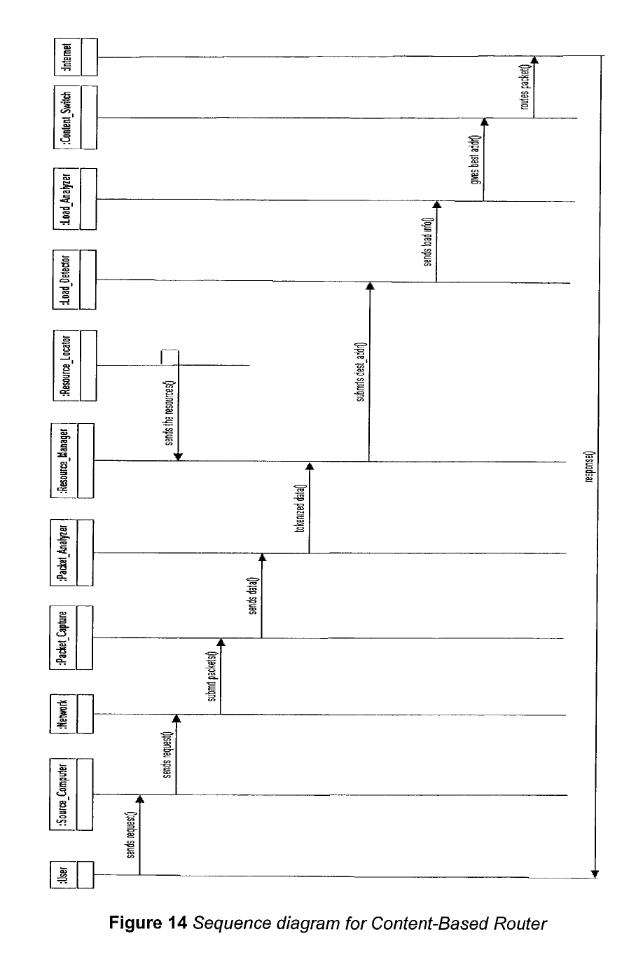

FIG. 13 shows the activity diagram for content-based router. The activity diagram shows the different activities and flows of data or decisions between the activities. Activity diagram is used in workflow analysis. It is also called as flowchart Activity diagram shows different activities handled by different objects. It can support parallel execution. Activity diagrams are used for detailed specification of complex systems with respect to implementation. FIG. 14 shows the sequence diagram of the system. The sequence diagram shows the relationship between two different objects. Each object is represented as vertical lines and shows how messages are sent between two objects. The sequence diagram is also known as interaction diagram. The messages that are sent between two objects are also called as events. An event takes place only when the target object replies back to its message.

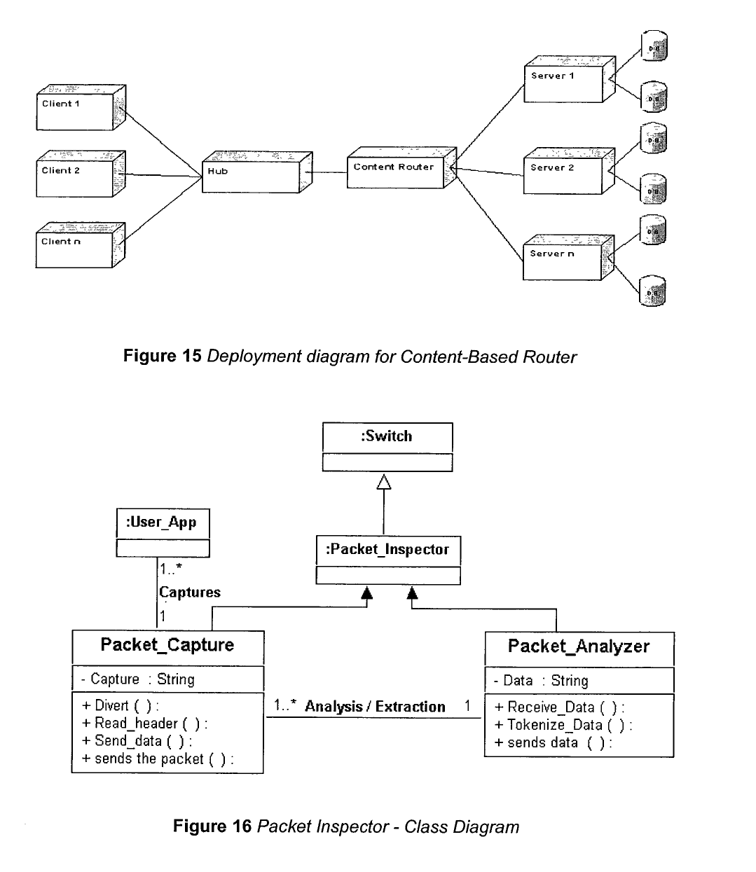

FIG. 15 shows the deployment diagram for content-based router. The deployment diagrams are used to describe the deployment architecture of the system. A three-dimensional box represents each node in deployment diagram. Each node represents different components of the system. The different nodes present in this system are the different clients, a network hub, which connects different computers together, a content router and different servers with different databases on it.

The Packet Inspector module enables the router to capture and extract the data in each packet of a user's request. This data is the content that is routed to the appropriate server at that moment based on a set of metrics. This component of the system intercepts the user's request data stream in the form of packets and then extracts the data content (i.e., the payload) it contains for routing. FIG. 16 shows the class diagram for packet inspector.

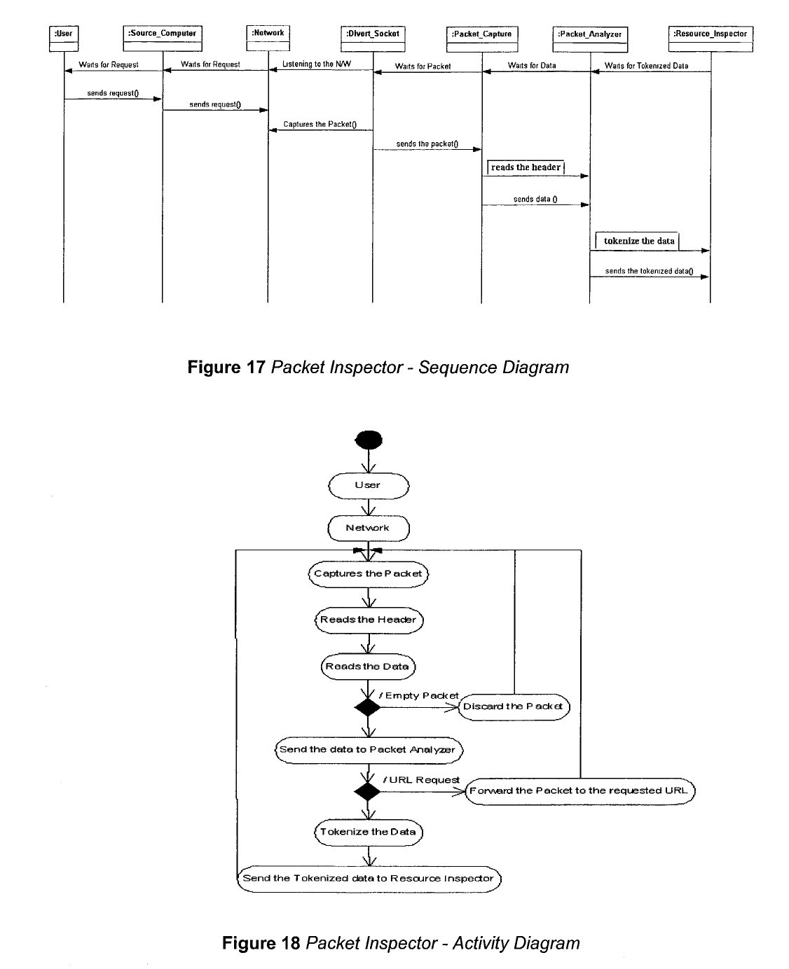

The Packet Capture and Packet Analyzer are the two sub-components of the Packet Inspector. The Packet Inspector unit captures and extracts the data in each packet of a user request. This extracted data is used for routing the packet to the appropriate server. FIG. 17 gives the Sequence diagram for the Packet Inspector. The Packet Capture component takes care of captures the packet and sends the data to the Packet Analyzer. The Packet Capture component opens a socket connection and listens for the packet that flows in the network. When the user sends in a request the socket grabs or captures the packet, and stops the packet flow from the current node or hop to the next node. The Packet Capture collects the captured packet, scans the header and the data field. By scanning the header and data field the Packet Capture finds the source address, destination address and the data in the packet. If the data field is empty the packet is discarded without any further processing. If the packet contains data, it is forwarded to the Packet Analyzer for processing. The Packet Analyzer converts the extracted data from the machine code to readable string format. The converted data is tokenized and a keyword or set of keywords is selected, which is sent to the next component of the system, the Resource Inspector. Algorithm 1 and FIG. 18 gives the pseudo code and Activity diagram for the Packet Inspector. Thus, the Packet Inspector intercepts the users request data stream in the form of packets and then extracts the data content, which is used for routing.

```
Algorithm 1 Packet Inspector
INPUT: User Request;
OUTPUT: Tokenized data in string format;
    WHILE (Network is active) DO
        Open a socket connection S;
        IF (S = −1) THEN
            Socket open error;
            Exit the system;
        IF (S >= 0) THEN
            Open a divert socket;
            Listen to a port for receiving the packets;
        FOREACH packet DO
        SWITCH (ether_type) IN
        CASE IP Packet:
            Divert the packet to the user level;
            Read the header and data;
            IF (data = null) THEN
                Discard the packet;
            ELSE convert the data to string format;
                Tokenize the data;
        CASE ARP Packet:
            Read the header;
            Forward the packet to the original destination;
        CASE RARP Packet:
            Read the header;
            Forward the packet to the original destination;
        OTHERWISE:
            IF (unknown packet type) THEN
                Forward the packet to the original destination;
        END {SWITCH};
    END {WHILE};
End of Algorithm;
```

The Packet Inspector component is implemented in C and Java. The components implemented in C are integrated into the other parts using Java's Native Interface facility. The protocol used for capturing the packets is the divert socket. The libpcap library file in C was used to capture the packets. The drawback in using libpcap is, it just gives a copy of the packet and forwards the packet to the next node. This drawback is avoided in divert sockets, because it actually grabs the packet from the network. The content of the packet is converted and analyzed using Java because it supports many classes and methods than any other language.

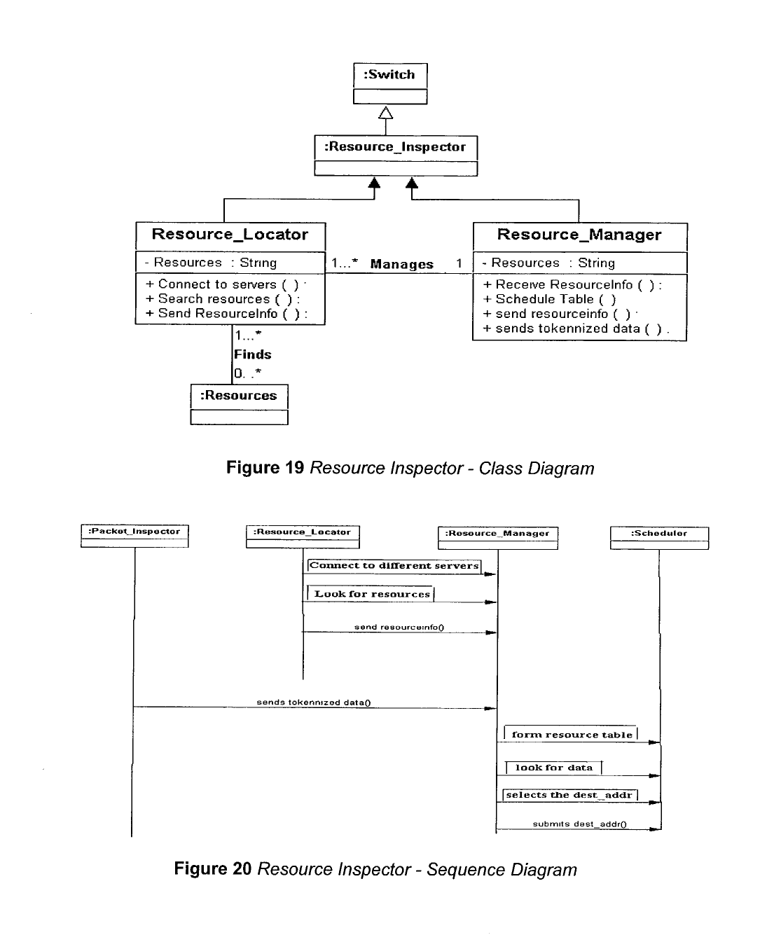

A core component of the system is the Resource Inspector. The main job of the Resource Inspector is to assemble vital information about the resources available in the system for ease of access and fast decision-making. To implement this component, we adopted intelligent mobile agent technology. Mobile agents are suitable because they enable us to seamlessly and transparently assess servers (at remote locations) and retrieve appropriate data of interest. The agents only need to know the address (IP address or full domain name) of the resource and a known set of database types. The agents can retrieve the metadata of each database, such as the name of the schemas, the description of the schemas, and table definitions, etc. This information is necessary to make informed judgements on where to find the available resources for the application. The databases are transparent to the system. FIG. 19 shows the class diagram for resource inspector.

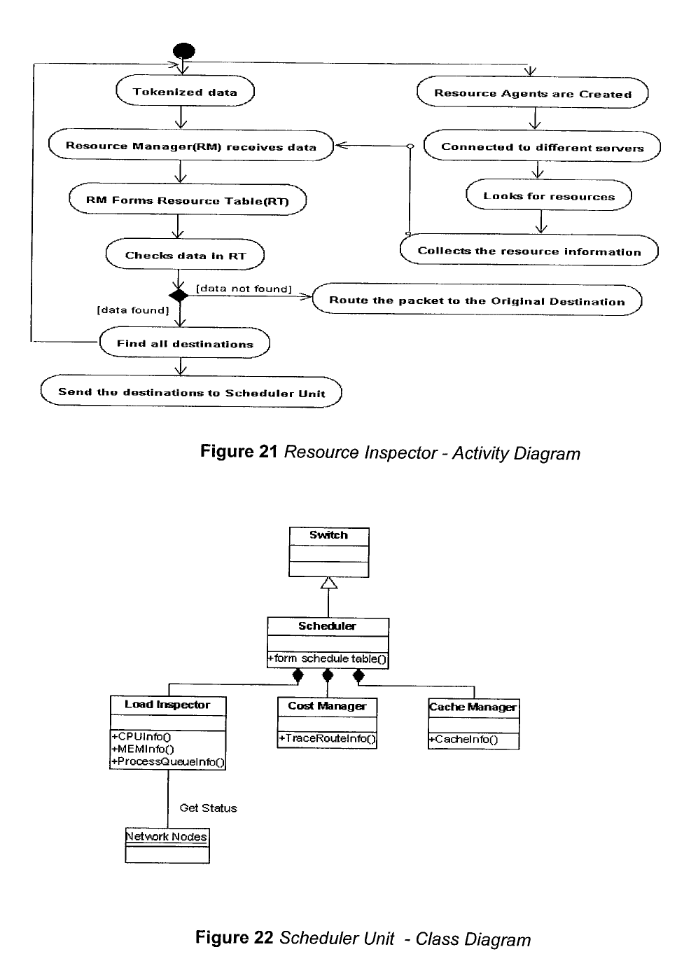

The Resource Locator and Resource Manager are the two sub-components of the Resource Inspector. The main job of the Resource Inspector is to assemble vital information about the resources available in the system for easy access and fast decision making. FIG. 20 gives the Sequence diagram for the Resource Inspector. The Resource Locator collects the resource information. The resources for e-commerce applications are often stored in databases at participating servers. The resources are heterogeneous because they are built using different database systems (e.g., Microsoft Access, Oracle, SQL Server, DB2, Sybase, etc). The agents extract the metadata of each database, such as the name of the schemas, the description of the schemas, and table definitions etc. These information are given to the Resource Manager to make informed judgements on where to find the available resources for the application. Based on the metadata information and the server address, the Resource Manager collects resource information about the number of databases available in the system, the address of these databases, and permissions on the databases and stores the collected data in a resource table. Algorithm 2 and 3 gives the pseudo code for Resource Locator and Resource Manager. FIG. 21 gives the Activity diagram for the Resource Inspector.

```
Algorithm 2 Resource Locator
INPUT: Server addresses;
OUTPUT: Resource information of various servers;
// Abbreviations used and there corresponding meaning.
    RM: Resource Manager;
FOREACH server DO
    Create resource agents;
WHILE (network is active) DO
    Open a connection with all servers;
    IF (server is active) THEN
        Send the resource agents to the assigned server;
        Collect the resource information for each server;
        Exit the system;
    ELSE wait for active connection with the server;
    END {IF};
    Send all the collected resource informations to RM;
END {WHILE};
End of Algorithm;
Algorithm 3 Resource Manager
INPUT: Tokenized data from Packet Inspector;
    Resource Informations from Resource Locator;
OUTPUT: Server address or addresses for the tokenized data;
// Abbreviations used and there corresponding meaning.
    RT: Resource table;
    SA: Server address or addresses;
    TD: Tokenized data;
    DL: Data Location;
RT is formed using the resource informations;
FOREACH tokenized data DO
    Look for SA;
WHILE (network is active) DO
    Search for TD in RT;
    IF (TD not found in RT) THEN
        Forward the packet to the original destination;
    ELSEIF (TD found in RT) THEN
        Find SA;
        Form a DL table using the SA;
        Send the DL table to the Scheduler unit;
    END {IF};
END {WHILE};
End of Algorithm;
```

While collecting the resources in the resource table the resource information are also copied into a file as backup information. The advantage of following this process is, even when the system is down or switched off all the information are stored, which can be used as soon as the system is recovered. The resource table has tow columns and n-number of rows. The Resource table is shown in FIG. 7.

The two columns in the resource table are the server address and the resources available in the server. The resource table is scanned for the tokenized data obtained from Packet Inspector to find the appropriate server or servers for processing the user request. The obtained server address or addresses are stored in a Data Location table. The data location table is shown in FIG. 8. The Data Location table is sent to the Scheduler unit for further processing. The implementation assumes that

All Server Addresses are known.

Permissions are granted on the servers.

Data Source Names for all the databases are known.

The databases are transparent to the system.

The Scheduler Unit is a major part of the system, uses the information assembled by the Resource Manager to facilitate content-based routing. It is responsible for scheduling and allocating transactions to the various servers for execution based on the current processing/work load information of each server. This unit answers questions such as: how busy is each server and which server can process the request in the shortest time. FIG. 22 gives the class diagram for scheduler.

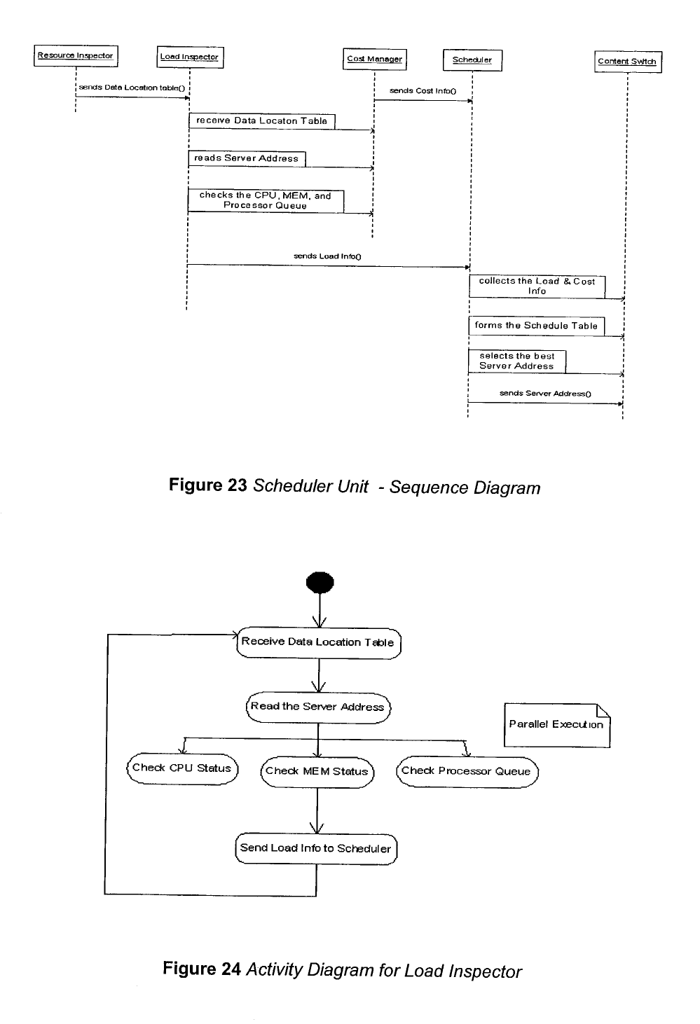

The different components of the Scheduler Unit are the Load Inspector, Cost Manager, Cache Manager and the Scheduler. The Scheduler selects a best and efficient destination address based on a set of metrics. The metrics include the load on the server and the distance between the client and the server. The following section discusses the functionality of each component elaborately. FIG. 23 gives the sequence diagram of the Scheduler Unit.

The Scheduler receives the Data Location Table from the Resource Inspector. For each entry in the table the Load Inspector creates Load Detector Agents. The agents are capable of moving from one location to another. Each entry in the Data Location Table has a server address. The Detector Agent reads the server address and enters the appropriate server to retrieve the Load information. Before entering the server the Detector Agent checks for the status of the server from the System Status Table (SST). The SST has the status information of all the participating servers. FIG. 9 shows the SST.

If the system is active the agent checks the percentage of CPU available for the next process, free Memory available and the length of the Processor Queue to find the total number of jobs waiting to get processed by the server. If the server is down or inactive the Detector Agent ignores the server and looks for the next Server Address in the Data Location table. The Detector Agent collects the load information and sends it to the Scheduler for further processing. Algorithm 4 gives the pseudo code and FIG. 24 gives the activity diagram for the Load Inspector.

```
Algorithm 4 Load Inspector
INPUT: Data Location table from Resource Inspector;
OUTPUT: Load information of all Servers in Data Location table;
// Abbreviations used and there corresponding meaning.
    SA: Server address;
    DL: Data Location;
    MEM: Memory;
    PQ: Processor Queue;
FOREACH entry in DL table DO
    Read SA;
WHILE (system is active) DO
    IF (first row not empty) THEN
        Check the CPU status for the SA;
        Check the MEM status for the SA;
        Check the PQ length for the SA;
    END {IF};
    Collect all the above information;
    Send the load information to the Scheduler;
END {WHILE};
End of Algorithm;
```

The Scheduler is implemented using Java. This component is implemented using Java Remote Method Invocation (RMI). The other approaches for implementing this module are Java Aglets and Simple Network Management Protocol (SNMP). In all the three approaches a Server should be running for the Resource Agents to collect the Resource information. The SNMP approach is very similar to the Remote Method Invocation. The SNMP server is same as the RMI Server. The SNMP is the standard protocol used for remote communication. The Java Aglets has its own Tahiti Server, which is built in with the Aglets Kit that has to be installed to use the Aglets. Aglets can create Mobile Agents that can roam from one machine to another. The advantage of using RMI is, we can have our own specification in creating the Server, which supports our application reducing the workload on the Server. Both Aglets and SNMP have a built-in Server, which is created to support all the applications. This increases the workload on the Server.

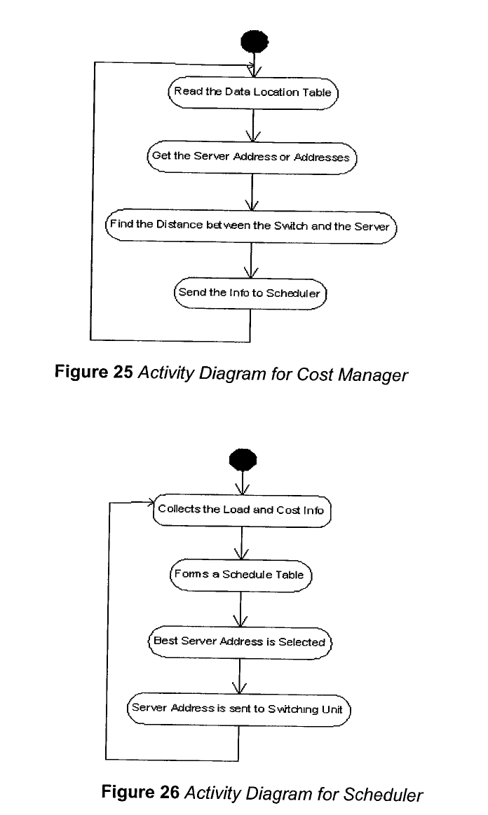

The next component in the Scheduler unit is the Cost manager. Cost Manager finds the distance between the client and the server. The Cost Manager creates a simple traceroute procedure, which is used to find the total number of hops, or nodes in between the client and the given server address and form a Proximity Table. FIG. 10 shows the Proximity Table. The Cost Manager reads the Data Location Table. Each row in the table is scanned for server address. For each scanned Server address, the distance information is obtained by looking into the Proximity Table. The distance information is sent to the Scheduler for further processing. Algorithm 5 gives the pseudo code and FIG. 25 gives the activity diagram for Cost Manager.

```
Algorithm 5 Cost Manager
INPUT: Data Location table from Resource Inspector;
OUTPUT: Number of nodes in between the content switch and each
Server in Data Location table;
// Abbreviations used and there corresponding meaning.
    SA: Server address;
    DL: Data Location;
FOREACH entry in DL table DO
    Read SA;
WHILE (system is active) DO
    IF (first row not empty) THEN
        Find the total number of nodes present in between the
        switch and the given server;
    END {IF};
    Send the information to the Scheduler;
END {WHILE};
End of Algorithm;
```

The next important component is the Scheduler. The Scheduler selects the best and efficient server address for routing the user request. The Scheduler collects the information from the Load Inspector and Cost Manager. Based on the collected information a Schedule table is formed. The Schedule table is shown in FIG. 11. Algorithm 6 gives the pseudocode and FIG. 26 gives the activity diagram for Scheduler.

```
Algorithm 6 Scheduler
INPUT: Load Information from Load Inspector;
        Cost Information from Cost Manager;
OUTPUT: Server Address for Routing user request;
// Abbreviations used and there corresponding meaning.
      SA: Server address;
      ST: Schedule Table;
WHILE (system is active) DO
      Collect all the information;
      Form a ST;
      Best and Efficient SA is selected based on set of metrics;
      Send the selected SA to Switching Unit;
END {WHILE};
End of Algorithm;
```

An efficient server address is selected from the Schedule table based on Algorithm 7. The selected server address is sent to the switching unit for routing the user request.

```
Algorithm 7 Selecting the Best Server Address
INPUT: Schedule Table formed by Scheduler;
OUTPUT: Best and Efficient Server Address is selected;
SA: Server address;
ST: Schedule Table;
CPU: % CPU Available;
MEM: %Memory Available;
QL: Queue Length;
DIST: Distance between the switch and the server;
FOREACH columns in ST assign different arrays;
        DO
        {
        Assign the 1^{st} row element of each array to a temporary
        variable T;
        Compare the T row elements with the next row (N) in ST;
        IF ((|diff (T (CPU), N (CPU)|) > 0.5) THEN
            {
        IF (T (DIST) < N (DIST)) THEN
            {
            T'th row elements are selected and the SA is selected
            as best destination Address;
            }
        ELSE
            {
            Select the N row elements and assign SA as
            best destination Address;
            }
        END {IF};
        IF (T (DIST) = = N (DIST)) THEN
            {
            The server, which has more CPU available, is selected
            as best destination address;
            }
ELSE (ignore the CPU available and compare the DIST)
        {
        IF (T (DIST) < N (DIST)) THEN
            {
            T'th row elements are selected and the SA is selected
            as best destination Address;
            }
        ELSEIF (T (DIST) > N (DIST)) THEN
            {
            Assign the temporary row to the next row elements
            and select the SA;
            }
        ELSE (ignore the DIST and compare the QL)
        END {IF};
        IF (T (QL) < N (QL)) THEN
            {
            T'th row elements are selected and the SA is selected
            as best destination Address;
            }
        ELSEIF (T (QL) > N (QL)) THEN
            {
            Assign the temporary row to the next row elements
            and select the SA;
            }
        ELSE (ignore the QL and compare the MEM)
        END {IF};
        IF (T (MEM) > N (MEM)) THEN
            {
            T'th row elements are selected and the SA is selected
            as best destination Address;
            }
        ELSEIF (T (MEM) < N (MEM)) THEN
            {
            Assign the temporary row to the next row elements
            and select the SA;
            }
        ELSE (ignore the MEM and find which server has more CPU
            available among the two rows);
        END {IF};
        IF (T (CPU) > N (CPU)) THEN
            {
            T'th row elements are selected and the SA is selected
            as best destination Address;
            }
        ELSEIF (T (CPU) < N (CPU)) THEN
            {
            Assign the temporary row to the next row elements
            and select the SA;
            }
        ELSE (select any row among the two compared rows and
            select the SA as the best destination address);
        END {IF};
        }
        END {IF};
        UNTIL all rows are compared;
END {DO};
End of Algorithm;
```

The next component in the Scheduler Unit is Cache Manager. It is a separate component inside the Scheduler Unit. The main functionality of the Cache is to get the Best and efficient destination address from the Scheduler and puts it into the cache with the corresponding data of interest for that server. When the request comes in from the client the router checks the cache for the requested data and its corresponding Server address. If the data is cached the router picks up the Server address and sends it to the Scheduler Unit for further processing. If the data is not available in the cache the router sends the tokenized data to the Resource Inspector to obtain an appropriate server address. This component is implemented in Java. The Cache is maintained in two different ways. The Surrogate Server or just a file can be maintained as a cache. Surrogate Server is similar to a cache where, the most frequently requested data is stored. The storage capacity in this server is very huge when compared to a file.

1. A method for directing packets of data in a telecommunications network,
wherein the network comprises a plurality of clients, a plurality of servers for supplying those services and a plurality of routers for directing communications over the network;
the method comprising:
providing a router for routing data packets within the network;
providing in the router a packet inspector which examines the data in the packet;
providing in the router a resource inspector which obtains from the network a set of metrics including network state information;
and using the data in each packet and the network state characteristics to determine a suitable destination address that can optimize the processing of the packet.

2. The router according to claim 1 wherein the router provides scalable services that can appropriately respond to varying processing loads.

3. The router according to claim 1 wherein the router provides the ability to track content requests and respond with appropriate content economically.

4. The router according to claim 1 wherein the router provides optimized routing based on application characteristics, thereby increasing bandwidth use on the Internet.

5. The router according to claim 1 wherein at least some of the packets are redirected to a different destination address than was originally specified.

6. The router according to claim 1 wherein the set of metrics includes network state information including transmission cost, speed, and traffic over various links as well as server proximity and workload.

7. The router according to claim 1 wherein the router is arranged to integrate both dynamic data with the limited static data to make intelligent routing decisions, wherein the dynamic data includes the amount of memory and percentage of processor power available at a router, the workload of the router, and the queue length at the router of a network and wherein the static data includes the packet's data and the IP addresses of potential servers that can service the request.

8. The router according to claim 1 wherein the verified content-based routing technology that is arranged to provide application-specific intelligent software routing environments to create more efficient geographically distributed databases and other similar applications.

9. The router according to claim 1 wherein the packet inspector uses Layers 3 through Layer 7 of the OSI model.

10. The router according to claim 1 wherein the Resource inspector finds load and resource information on each server dynamically and provides the collected information to other components of the router in order to process the client request.

11. The router according to claim 1 wherein the packet inspector is arranged to examine all type of TCP-based requests.

12. The router according to claim 1 wherein the router consists of four major components embedded within a single unit including, in addition to the Packet Inspector and the Resource Inspector, a Scheduler and a Switching Unit.

13. The router according to claim 12 wherein the Packet Inspector has two sub-components, the Packet Capture and the Packet Analyzer which enable the unit to capture and extract the data in each packet wherein the extracted data is sent to the scheduler to select an efficient server to process the client's request.

14. The router according to claim 13 wherein the packet inspector uses C programming language for capturing the packet and Java for analyzing and extracting the data.

15. The router according to claim 1 wherein the Resource Inspector has two sub-components, the Resource Locator and the Resource Manager wherein the Resource Locator collects different resource information from different servers by sending resource agents to different servers and wherein the collected resource information is given to the Resource Manager which organizes and manages the information and forms a Resource Table which contains the resource name and the server address.

16. The router according to claim 15 wherein extracted data from a packet is scanned in the Resource Table to locate the server address or addresses to forms a Data Location Table which is sent to the Scheduler for further processing.

17. The router according to claim 1 wherein Algorithms for locating the resources and forming the RT and DL tables are substantially as set forth in Algorithms 2 and 3.

18. The router according to claim 1 wherein the Scheduler has three sub-components, the Load Inspector, the Cost Manager and the Cache Manager, wherein the Load Inspector extracts the load information of different servers present in the Data Location Table and checks for the server's status, wherein the Cost Manager measures the distance between the client and the participating servers and wherein the Cache Manager collects the best and efficient server address with the extracted data and stores it in the cache.

19. The router according to claim 18 wherein the Algorithms for the Load Inspector, the Cost Manager and the Cache Manager are substantially as set forth in Algorithms 4-7.

20. The router according to claim 1 wherein the router is arranged for e-commerce applications using the UML paradigm.

21. The router according to claim 1 wherein router uses the Z specification language to guarantee correctness and prove the reliability of the design.
